(19) United States
(12) Patent Application Publication
(10) Pub. No.: US 2013/0176390 A1
(43) Pub. Date: Jul. 11, 2013

(54) MULTI-HYPOTHESIS DISPARITY VECTOR CONSTRUCTION IN 3D VIDEO CODING WITH DEPTH

(71) Applicant: QUALCOMM INCORPORATED, San Diego, CA (US)

(72) Inventors: Ying Chen, San Diego, CA (US); Marta Karczewicz, San Diego, CA (US)

(73) Assignee: QUALCOMM INCORPORATED, San Diego, CA (US)

(21) Appl. No.: 13/733,704

(22) Filed: Jan. 3, 2013

Related U.S. Application Data
(60) Provisional application No. 61/584,089, filed on Jan. 6, 2012.

(51) Int. Cl. H04N 13/00

(52) U.S. Cl. CPC H04N 13/0048
USPC 348/43

(57) ABSTRACT

A method and apparatus for decoding and encoding multiview video data is described. An example method may include coding a block of video data using a motion vector prediction process, determining a motion vector candidate list, determining a disparity vector candidate list for the motion prediction process, wherein the disparity vector candidate list includes at least two types of disparity vectors from a plurality of disparity vector types, the plurality including a spatial disparity vector (SDV), a smooth temporal-view (STV) disparity vector, a view disparity vector (VDV), and a temporal disparity vector (TDV), and performing the motion vector prediction process using one of the disparity vector candidate list and the motion vector candidate list.

This application claims the benefit of U.S. Provisional Application No. 61/584,089, filed Jan. 6, 2012, the entire content of which is incorporated herein by reference.

### TECHNICAL FIELD

This disclosure relates to techniques for video coding, and more specifically to techniques for 3D video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Extensions of some of the aforementioned standards, including H.264/AVC, provide techniques for multiview video coding in order to produce stereo or three-dimensional (“3D”) video. In particular, techniques for multiview coding have been proposed for use in AVC, with the scalable video coding (SVC) standard (which is the scalable extension to H.264/AVC), and the multi-view video coding (MVC) standard (which has become the multiview extension to H.264/AVC).

Typically, stereo video is achieved using two views, e.g., a left view and a right view. A picture of the left view can be displayed substantially simultaneously with a picture of the right view to achieve a three-dimensional video effect. For example, a user may wear polarized, passive glasses that filter the left view from the right view. Alternatively, the pictures of the two views may be shown in rapid succession, and the user may wear active glasses that rapidly shutter the left and right eyes at the same frequency, but with a 90 degree shift in phase.

### SUMMARY

In general, this disclosure describes techniques for 3D video coding. In particular, this disclosure is related to multi-hypothesis disparity vector construction in multiview plus depth video coding.

In one example of the disclosure, a method of decoding multiview video data comprises determining a motion vector candidate list for a motion vector prediction process, determining a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and performing the motion vector prediction process using one or more of the candidates in the disparity vector candidate list to decode a block of video data using the motion vector prediction process.

In another example of the disclosure, a method of encoding multiview video data comprises determining a motion vector candidate list for a motion vector prediction process, determining a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and performing the motion vector prediction process using one or more of the candidates in the disparity vector candidate list to encode a block of video data using the motion vector prediction process.

In another example of the disclosure, an apparatus configured to decode multiview video data comprises a video decoder configured to determine a motion vector candidate list for a motion vector prediction process, determine a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to decode a block of video data using the motion vector prediction process.

In another example of the disclosure, an apparatus configured to encode multiview video data comprises a video encoder configured to determine a motion vector candidate list for a motion vector prediction process, determine a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to encode a block of video data using the motion vector prediction process.

In another example of the disclosure, an apparatus configured to decode multiview video data comprises means for determining a motion vector candidate list for a motion vector prediction process, means for determining a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and means for performing the motion vector prediction process using one or more of the candidates in the disparity vector candidate list to decode a block of video data using the motion vector prediction process.

In another example of the disclosure, an apparatus configured to encode multiview video data comprises means for determining a motion vector candidate list for a motion vector prediction process, means for determining a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and means for performing the motion vector prediction process using one or more of the candidates in the disparity vector candidate list to encode a block of video data using the motion vector prediction process.

In another example of the disclosure, a computer-readable storage medium storing instructions that, when executed, cause one or more processers of a device configured to decode multiview video data to determine a motion vector candidate list for a motion vector prediction process, determine a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to decode a block of video data using the motion vector prediction process.

In another example of the disclosure, a computer-readable storage medium storing instructions that, when executed, cause one or more processers of a device configured to determine a motion vector candidate list for a motion vector prediction process, determine a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to encode a block of video data using the motion vector prediction process.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating an example multiview decoding order.

FIG. 3 is a conceptual diagram illustrating an example prediction structure for multiview coding.

FIG. 4 is a conceptual diagram illustrating candidate blocks for a motion vector prediction process.

FIG. 5 is a conceptual diagram illustrating the generation of an initial depth map estimate after coding the first dependent view of a random access unit.

FIG. 6 is a conceptual diagram illustrating the derivation of a depth map estimate for the current picture using motion parameters of an already coded view of the same access unit.

FIG. 7 is a conceptual diagram illustrating a process for updating a depth map estimate for a dependent view based on coded motion and disparity vectors.

FIG. 8 is a block diagram illustrating an example video encoder that may implement the techniques described in this disclosure.

FIG. 9 is a block diagram illustrating an example video decoder that may implement the techniques described in this disclosure.

FIG. 10 is a flowchart illustrating an example decoding method according to the techniques of this disclosure.

FIG. 11 is a flowchart illustrating an example encoding method according to the techniques of this disclosure.

### DETAILED DESCRIPTION

In general, this disclosure describes techniques for multiview (e.g., 3D) video coding based on advanced codecs, including the coding of two or more views with the high efficiency video coding (HEVC) codec. In some examples, techniques related to disparity vector construction in HEVC-based multiview plus depth video coding (sometimes called 3DV or 3D-HEVC) are proposed. However, the techniques of this disclosure may be generically applicable to any multiview plus depth video coding techniques, including H.264/Advanced Video Coding (AVC) techniques using multiview plus depth.

This disclosure is related to 3D video coding based on advanced codecs, including the coding of two or more views of a picture with depth maps. The 3D video coding techniques of H.264/AVC techniques will be discussed initially. However, the techniques of this disclosure may be applicable to any video coding standard that supports 3D coding and view synthesis prediction.

Other video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The latest joint draft of MVC is described in “Advanced video coding for generic audiovisual services,” ITU-T Recommendation H.264, March 2010. In addition, a new video coding standard, namely the High-Efficiency Video Coding (HEVC), is currently being developed by the Joint Collaboration Team on Video Coding (JCT-VC) of ITU-T Video Coding Experts Group (VCEG) and ISO/IEC Motion Picture Experts Group (MPEG). One working draft (WD) of HEVC is described in JCTVC-G1103, “WD5: Working Draft 5 of High-Efficiency Video Coding,” 7th Meeting: Geneva, CH, 21-30 Nov., 2011. A more recent WD of HEVC is described in JCTVC-K1003, “High Efficiency Video Coding (HEVC) text specification draft 9,” 11^{th} Meeting: Shanghai, CN, 10-19 Oct. 2012, and as of Dec. 17, 2012, is available for download at http://phenix.int-evry.fr/jct/doc_end_user/documents/11_Shanghai/wg11/JCTVC-K1003-v12.zip, the entire content of which is incorporated herein by reference.

As will be discussed in more detail below, current proposals for multiview extensions of HEVC, including multiview plus depth extensions, allow the use of both disparity vectors and motion vectors in candidate lists used for motion vector prediction. However, such proposals present drawbacks in terms of signaling inefficiencies, as well as potential error propagation problems in situations where depth values are calculated from disparity vectors. In view of these drawbacks, the present disclosure describes techniques for using multiple types of disparity vectors (i.e., multi-hypothesis disparity vector construction) in a candidate list for motion vector prediction.

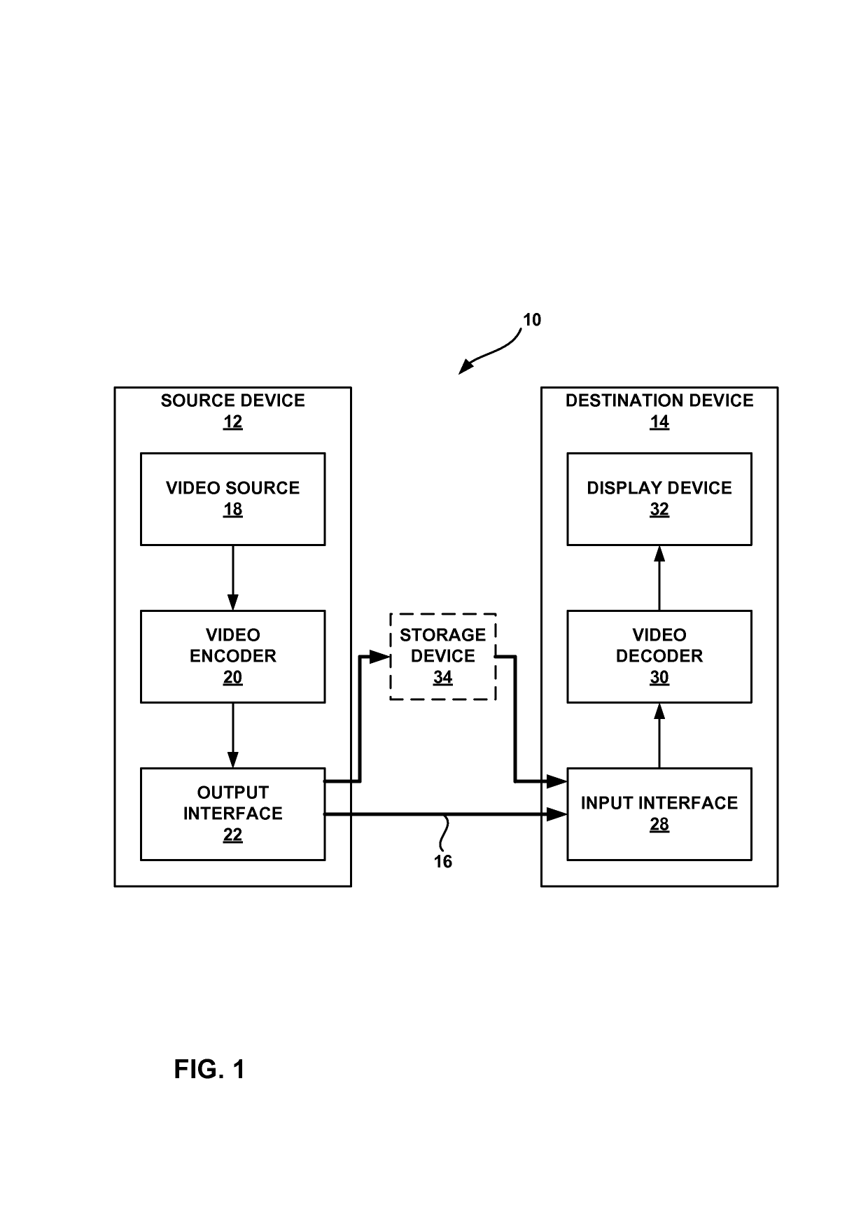

FIG. 1 is a block diagram illustrating an example video encoding and decoding system 10 that may utilize the techniques for multi-hypothesis disparity vector construction described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming devices, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure for multi-hypothesis disparity vector construction are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). In particular, in some examples, video encoder 20 and video decoder may operate according to extensions of HEVC that support multiview plus depth video coding (sometimes called 3DV or 3D-HEVC). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263. In particular, in accordance with techniques of this disclosure, video encoder 20 and video decoder 30 may operate according to a video coding standard capable of 3DV and/or multiview encoding (e.g., 3D-HEVC, H.264/MVC, etc.).

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In accordance with examples of the disclosure described in more detail below, video decoder 30 of FIG. 1 may be configured to determine a motion vector candidate list for a motion vector prediction process, determine a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to decode a block of video data using the motion vector prediction process.

Likewise, in another example of the disclosure, video encoder 20 of FIG. 1 may be configured to determine a motion vector candidate list for a motion vector prediction process, determine a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV), and perform the motion vector prediction process using one or more of the candidates in the disparity vector candidate list to encode a block of video data using the motion vector prediction process.

Initially, the multiview video coding techniques of extensions of the H.264/Advanced Video Coding (AVC) standard will be discussed. However, the techniques of this disclosure may be applicable with any video coding standard that supports 3D coding and view synthesis prediction, including multiview proposals for the emerging HEVC standard (e.g., 3D-HEVC).

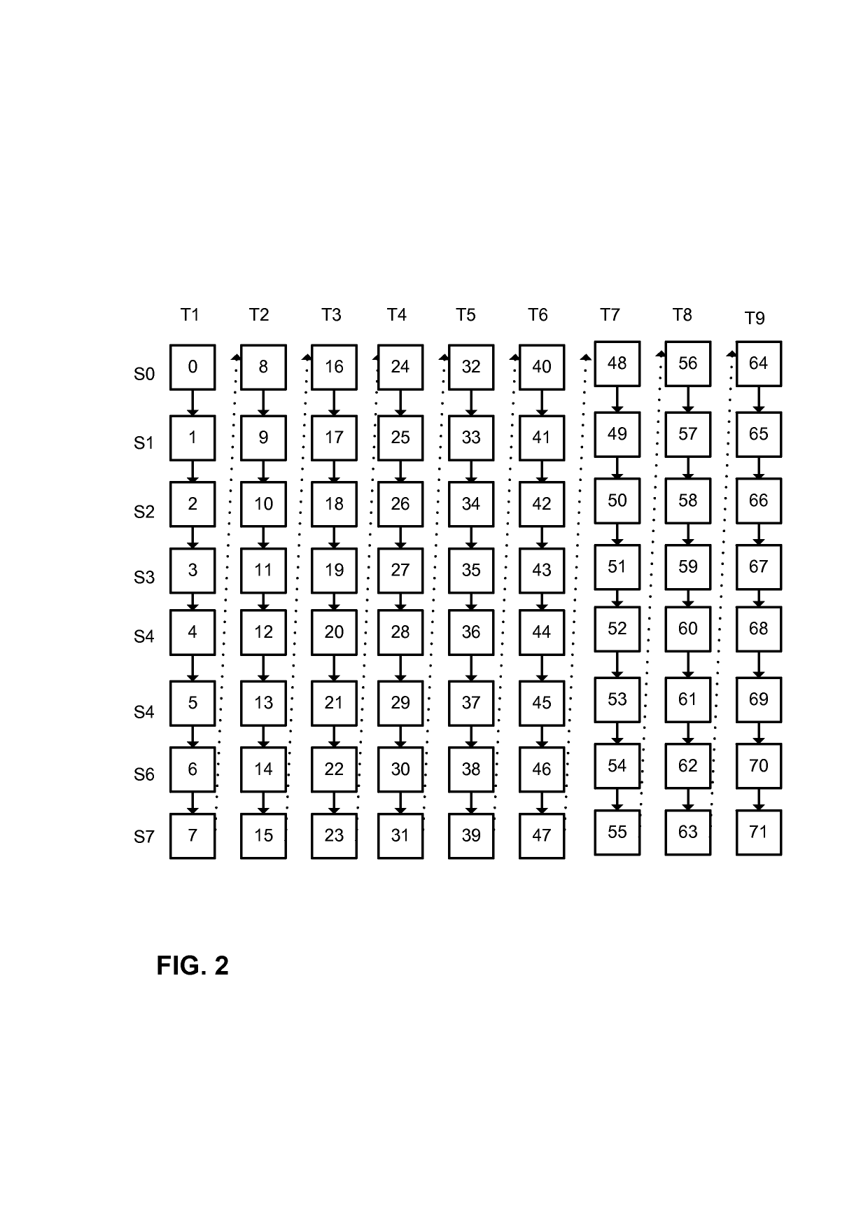

Multiview video coding (MVC) is an extension of H.264/AVC. A typical MVC decoding order (i.e. bitstream order) is shown in FIG. 2. The decoding order arrangement is referred as time-first coding. Note that the decoding order of access units may not be identical to the output or display order. In FIG. 2, S0-S7 each refers to different views of the multiview video. T0-T8 each represents one output time instance. An access unit may include the coded pictures of all the views for one output time instance. For example, a first access unit may include all of the views S0-S7 for time instance T0, a second access unit may include all of the views S0-S7 for time instance T1, and so forth.

For purposes of brevity, the disclosure may use the following definitions:

view component: A coded representation of a view in a single access unit. When a view includes both coded texture and depth representations, a view component consists of a texture view component and a depth view component.

texture view component: A coded representation of the texture of a view in a single access unit.

depth view component: A coded representation of the depth of a view in a single access unit.

In FIG. 2, each of the views includes sets of pictures. For example, view S0 includes set of pictures 0, 8, 16, 24, 32, 40, 48, 56, and 64, view S1 includes set of pictures 1, 9, 17, 25, 33, 41, 49, 57, and 65, and so forth. Each set includes two pictures: one picture is referred to as a texture view component, and the other picture is referred to as a depth view component. The texture view component and the depth view component within a set of pictures of a view may be considered as corresponding to one another. For example, the texture view component within a set of pictures of a view is considered as corresponding to the depth view component within the set of the pictures of the view, and vice-versa (i.e., the depth view component corresponds to its texture view component in the set, and vice-versa). As used in this disclosure, a texture view component that corresponds to a depth view component may be considered as the texture view component and the depth view component being part of a same view of a single access unit.

The texture view component includes the actual image content that is displayed. For example, the texture view component may include luma (Y) and chroma (Cb and Cr) components. The depth view component may indicate relative depths of the pixels in its corresponding texture view component. As one example, the depth view component is a gray scale image that includes only luma values. In other words, the depth view component may not convey any image content, but rather provide a measure of the relative depths of the pixels in the texture view component.

For example, a purely white pixel in the depth view component indicates that its corresponding pixel or pixels in the corresponding texture view component is closer from the perspective of the viewer, and a purely black pixel in the depth view component indicates that its corresponding pixel or pixels in the corresponding texture view component is further away from the perspective of the viewer. The various shades of gray in between black and white indicate different depth levels. For instance, a very gray pixel in the depth view component indicates that its corresponding pixel in the texture view component is further away than a slightly gray pixel in the depth view component. Because only gray scale is needed to identify the depth of pixels, the depth view component need not include chroma components, as color values for the depth view component may not serve any purpose.

The depth view component using only luma values (e.g., intensity values) to identify depth is provided for illustration purposes and should not be considered limiting. In other examples, any technique may be utilized to indicate relative depths of the pixels in the texture view component.

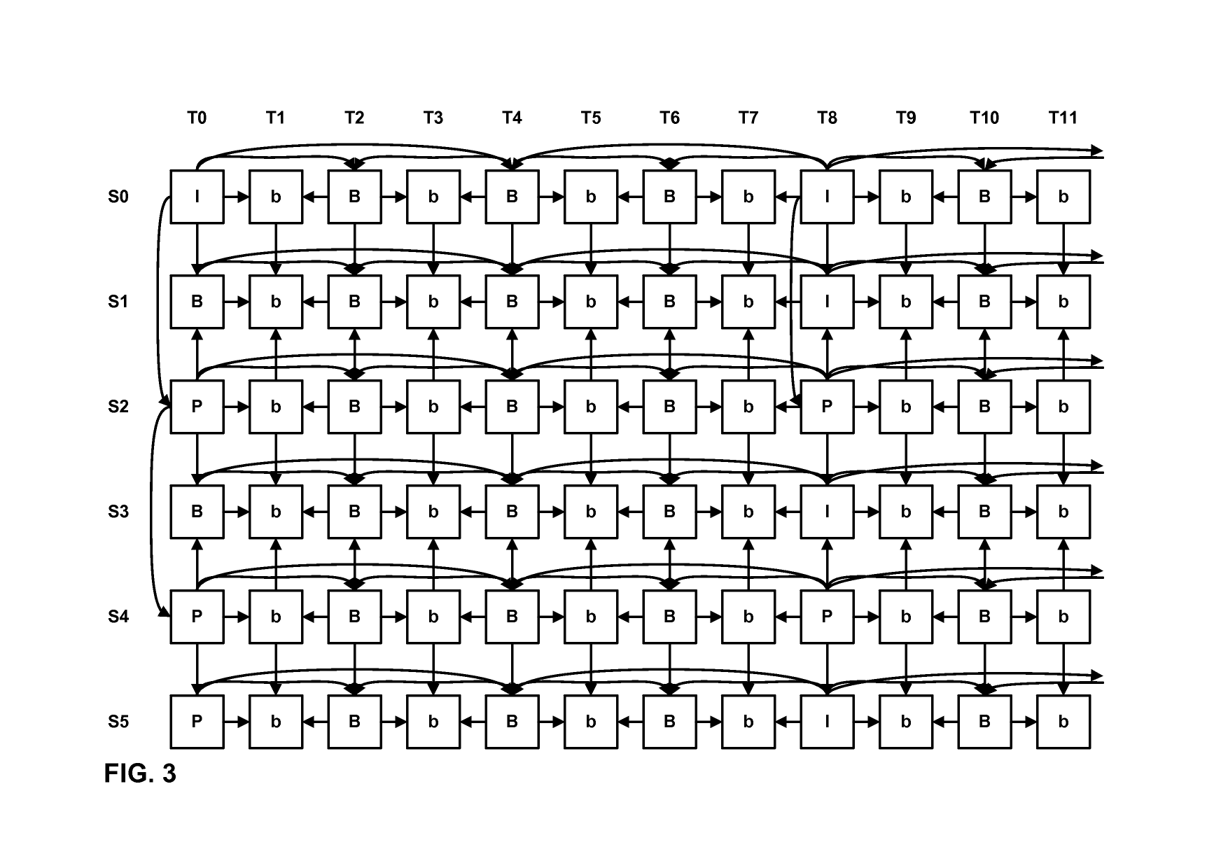

A typical MVC prediction structure (including both inter-picture prediction within each view and inter-view prediction) for multi-view video coding is shown in FIG. 3. Prediction directions are indicated by arrows, the pointed-to object using the pointed-from object as the prediction reference. In MVC, inter-view prediction is supported by disparity motion compensation, which uses the syntax of the H.264/AVC motion compensation, but allows a picture in a different view to be used as a reference picture.

In the example of FIG. 3, six views (having view IDs “S0” through “S5”) are illustrated, and twelve temporal locations (“T0” through “T11”) are illustrated for each view. That is, each row in FIG. 3 corresponds to a view, while each column indicates a temporal location.

Although MVC has a so-called base view, which is decodable by H.264/AVC decoders, and stereo view pairs could be supported also by MVC, the advantage of MVC is that it could support an example that uses more than two views as a 3D video input and decodes this 3D video represented by the multiple views. A renderer of a client having an MVC decoder may expect 3D video content with multiple views.

Pictures in FIG. 3 are indicated at the intersection of each row and each column. The H.264/AVC standard may use the term frame to represent a portion of the video. This disclosure may use the term picture and frame interchangeably.

The pictures in FIG. 3 are illustrated using a block including a letter, the letter designating whether the corresponding picture is intra-coded (that is, an I-picture), or inter-coded in one direction (that is, as a P-picture) or in multiple directions (that is, as a B-picture). In general, predictions are indicated by arrows, where the pointed-to pictures use the pointed-from picture for prediction reference. For example, the P-picture of view S2 at temporal location T0 is predicted from the I-picture of view S0 at temporal location T0.

As with single view video encoding, pictures of a multiview video coding video sequence may be predictively encoded with respect to pictures at different temporal locations. For example, the b-picture of view S0 at temporal location T1 has an arrow pointed to it from the I-picture of view S0 at temporal location T0, indicating that the b-picture is predicted from the I-picture. Additionally, however, in the context of multiview video encoding, pictures may be inter-view predicted. That is, a view component can use the view components in other views for reference. In MVC, for example, inter-view prediction is realized as if the view component in another view is an inter-prediction reference. The potential inter-view references are signaled in the Sequence Parameter Set (SPS) MVC extension and can be modified by the reference picture list construction process, which enables flexible ordering of the inter-prediction or inter-view prediction references. Inter-view prediction is also a feature of proposed multiview extension of HEVC, including 3D-HEVC (multiview plus depth).

FIG. 3 provides various examples of inter-view prediction. Pictures of view S1, in the example of FIG. 3, are illustrated as being predicted from pictures at different temporal locations of view S1, as well as inter-view predicted from pictures of views S0 and S2 at the same temporal locations. For example, the b-picture of view S1 at temporal location T1 is predicted from each of the B-pictures of view S1 at temporal locations T0 and T2, as well as the b-pictures of views S0 and S2 at temporal location T1.

In some examples, FIG. 3 may be viewed as illustrating the texture view components. For example, the I-, P-, B-, and b-pictures illustrated in FIG. 2 may be considered as texture view components for each of the views. In accordance with the techniques described in this disclosure, for each of the texture view components illustrated in FIG. 3 there is a corresponding depth view component. In some examples, the depth view components may be predicted in a manner similar to that illustrated in FIG. 3 for the corresponding texture view components.

Coding of two views may also be supported by MVC. One of the advantages of MVC is that an MVC encoder may take more than two views as a 3D video input and an MVC decoder may decode such a multiview representation. As such, any renderer with an MVC decoder may decode 3D video content with more than two views.

As discussed above, in MVC, inter-view prediction is allowed among pictures in the same access unit (meaning, in some instances, with the same time instance). When coding a picture in one of the non-base views, a picture may be added into a reference picture list, if it is in a different view but within a same time instance. An inter-view prediction reference picture may be put in any position of a reference picture list, just like any inter-prediction reference picture. As shown in FIG. 3, a view component can use the view components in other views for reference. In MVC, inter-view prediction is realized as if the view component in another view was an inter-prediction reference.

The techniques for multi-hypothesis disparity vector construction according to this disclosure may be applicable for any multiview or 3D video coding standard that utilizes disparity vectors. In some examples of this disclosure, the multi-hypothesis disparity vector construction techniques may be used with multiview extensions of the emerging HEVC standard (e.g., 3D-HEVC). The following section of the disclosure will provide a background of the HEVC standard.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU generally corresponds to a size of the coding node and must typically be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector, which may be indicated by a prediction direction.

In general, a TU is used for the transform and quantization processes. A given CU having one or more PUs may also include one or more transform units (TUs). Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In the HEVC WD9, there are two modes for the prediction of motion parameters used in inter-prediction. One mode is the merge mode and the other is the advanced motion vector prediction (AMVP) mode. Both merge and AMVP modes build a candidate list for reference pictures list 0 and 1 (which are commonly denoted as “RefPicList0” and “RefPicList1,” respectively).

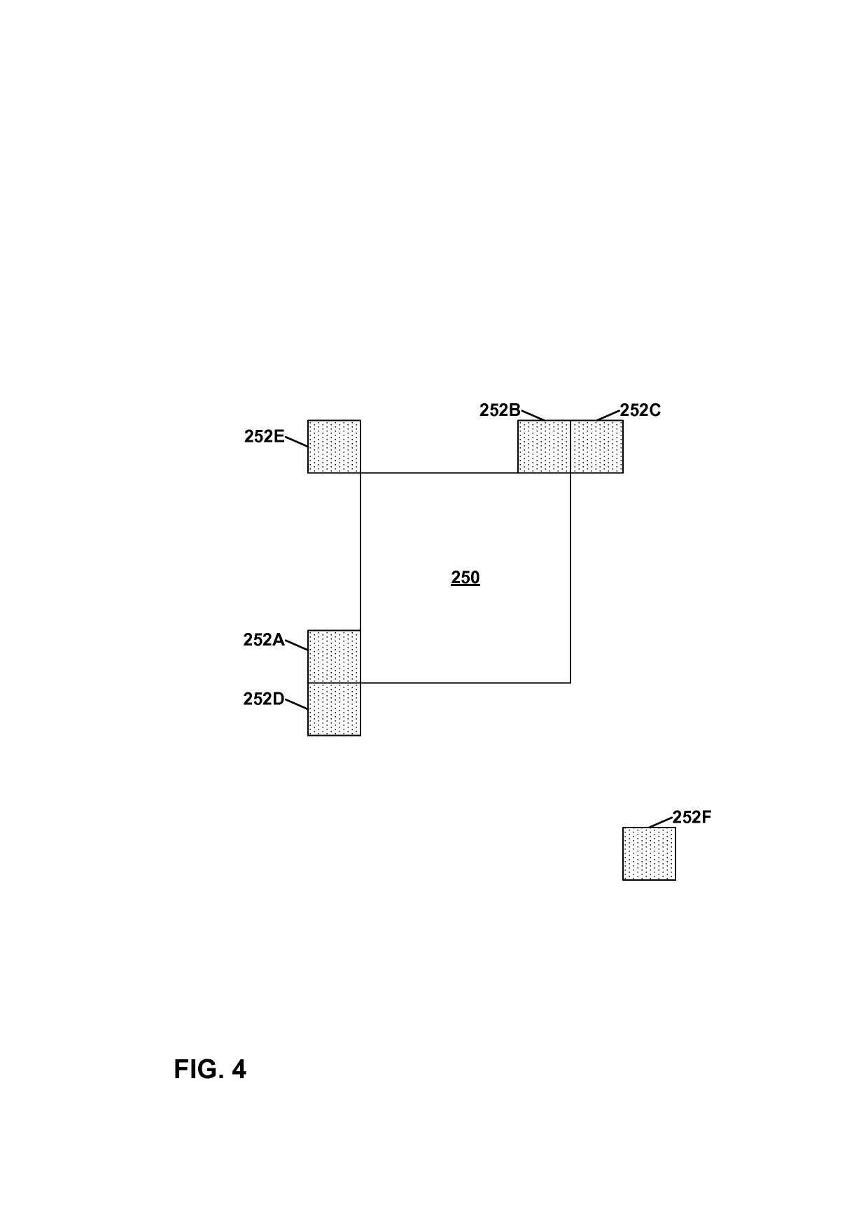

Candidates for AMVP and merge mode to be used for the coding of motion parameters are from spatial and temporal neighboring blocks relative to a current block (e.g., a prediction unit (PU)). FIG. 4 is a conceptual drawing showing example candidate neighbor blocks (i.e., the candidate list) for merge and AMVP mode. As shown in FIG. 4, current PU 250 may use the motion information from one of spatially neighboring blocks 252A-E. In addition, the candidate list for merge and AMVP modes may also include a temporally co-located block 252F in a different picture. The number and positions of candidate blocks shown in FIG. 4 is just one example. Different numbers and positions of candidate blocks could be used. In some examples, merge mode and AMVP mode have a candidate list of a fixed length. In some examples, the length of the candidate list for merge and AMVP may be different. For example, merge mode may use 5 candidate blocks, while AMVP may use 6.

In the AMVP mode, the motion vectors of neighbor candidate blocks are checked to determine which motion vector provides for acceptable rate-distortion performance (e.g., rate-distortion performance better than some threshold). Then, the motion vector of the neighboring candidate block is subtracted from the motion vector of the current block to create a motion vector difference (MVD). The MVD is then signaled in the encoded bitstream along with the candidate block index (mvp_idx), the MVD, and the reference picture index of the motion vector for the current block. In addition, the prediction direction (e.g., uni-direction or bi-directional) may be signaled, thereby signaling whether the reference picture is in List 0 or List 1.

In the merge mode, reference index values are not signaled since the current prediction unit (PU) shares the reference index values of the chosen candidate. That is, in merge mode, once a candidate block that meets the rate-distortion criteria has been selected, only the index of the candidate block is signaled. At the decoder, the motion information (i.e., the motion vector, reference index, and prediction direction) of the candidate block is used as the motion information for the current block. In merge mode, only one candidate list is created.

The syntax for merge mode and AMVP mode are described below. In the merge mode, merge_idx is used to choose a candidate from the merge mode candidate list. In the AMVP mode, mvp_idx_{—}10, mvp_idx_{—}11 and mvp_idx_{—}1c are used to choose candidates from the AMVP candidate list. The number of entries for both the merge mode and the AMVP mode is fixed. The coding unit (CU) syntax is shown in Table 1 and the PU syntax is shown in Table 2:

TABLE 1
CU Level Syntax

| coding_unit( x0, y0, log2CUSize ) { | Descriptor |
|---|---|
| if( slice_type != I ) | |
| skip_flag[ x0 ][ y0 ] | ae(v) |
| if( skip_flag[ x0 ][ y0 ] ) | |
| prediction_unit( x0, y0 , log2CUSize ) | |
| else if( slice_type != I \|\| log2CUSize = = | |
| Log2MinCUSize ) { | |
| pred_type | ae(v) |
| x1 = x0 + ( ( 1 << log2CUSize ) >> 1 ) | |
| y1 = y0 + ( ( 1 << log2CUSize ) >> 1 ) | |
| x2 = x1 − ( ( 1 << log2CUSize ) >> 2 ) | |
| y2 = y1 − ( ( 1 << log2CUSize ) >> 2 ) | |
| x3 = x1 + ( ( 1 << log2CUSize ) >> 2 ) | |
| y3 = y1 + ( ( 1 << log2CUSize ) >> 2 ) | |
| if( PartMode == PART_2N×2N ) { | |
| prediction_unit( x0, y0 , log2CUSize ) | |
| } else if( PartMode == PART_2N×N ) { | |
| prediction_unit( x0, y0 , log2CUSize ) | |
| prediction_unit( x0, y1 , log2CUSize ) | |
| } else if( PartMode == PART_N×2N ) { | |
| prediction_unit( x0, y0 , log2CUSize ) | |
| prediction_unit( x1, y0 , log2CUSize ) | |
| } else if( PartMode == PART_2N×nU ) { | |
| prediction_unit( x0, y0 , log2CUSize ) | |
| prediction_unit( x0, y2 , log2CUSize ) | |
| } else if( PartMode == PART_2N×nD ) { | |
| prediction_unit( x0, y0 , log2CUSize ) | |
| prediction_unit( x0, y3 , log2CUSize ) | |
| } else if( PartMode == PART_nL×2N ) { | |
| prediction_unit( x0, y0 , log2CUSize ) | |
| prediction_unit( x2, y0 , log2CUSize ) | |
| } else if( PartMode == PART nR×2N ) { | |
| prediction_unit( x0, y0 , log2CUSize ) | |
| prediction_unit( x3, y0 , log2CUSize ) | |
| } else { /* PART_N×N */ | |
| prediction_unit( x0, y0 , log2CUSize ) | |
| prediction_unit( x1, y0 , log2CUSize ) | |
| prediction_unit( x0, y1 , log2CUSize ) | |
| prediction_unit( x1, y1 , log2CUSize ) | |
| } | |
| if( !pcm_flag ) { | |
| transform_tree( x0, y0, log2CUSize, log2CUSize, 0, 0 ) | |
| transform_coeff( x0, y0, log2CUSize, log2CUSize, 0, 0 ) | |
| transform_coeff( x0, y0, log2CUSize, log2CUSize, 0, 1 ) | |
| transform_coeff( x0, y0, log2CUSize, log2CUSize, 0, 2 ) | |
| } | |
| } | |
| } | |

TABLE 2
PU Level Syntax

| prediction_unit( x0, y0, log2CUSize ) { | Descriptor |
|---|---|
| if( skip_flag[ x0 ][ y0 ] ) { | |
| merge_idx[ x0 ][ y0 ] | ae(v) |
| } else if( PredMode = = MODE_INTRA ) { | |
| if( PartMode == PART_2N×2N && | |
| log2CUSize >= Log2MinIPCMCUSize ) | |
| pcm_flag | ae(v) |
| if( pcm_flag ) { | |
| while ( !byte_aligned( ) ) | |
| pcm_alignment_zero_bit | u(v) |
| for( i = 0; i < 1 << ( log2CUSize << 1 ); i++ ) | |
| pcm_sample_luma[ i ] | u(v) |
| for( i = 0; i < ( 1 << ( log2CUSize << 1 ) ) >> 1; | |
| i++ ) | |
| pcm_sample_chroma[ i ] | u(v) |
| } else { | |
| prev_intra_luma_pred_flag[ x0 ][ y0 ] | ae(v) |
| if( prev_intra_luma_pred_flag[ x0 ][ y0 ] ) | |
| mpm_idx[ x0 ][ y0 ] | ae(v) |
| else | |
| rem_intra_luma_pred_mode[ x0 ][ y0 ] | ae(v) |
| intra_chroma_pred_mode[ x0 ][ y0 ] | ae(v) |
| SignaledAsChromaDC = | |
| ( chroma_pred_from_luma_enabled_flag ? | |
| intra_chroma_pred_mode[ x0 ][ y0 ] == 3 : | |
| intra_chroma_pred_mode[ x0 ][ y0 ] == 2 ) | |
| } | |
| } else { /* MODE_INTER */ | |
| merge_flag[ x0 ][ y0 ] | ae(v) |
| if( merge_flag[ x0 ][ y0 ] ) { | |
| merge_idx[ x0 ][ y0 ] | ae(v) |
| } else { | |
| if( slice_type = = B ) | |
| inter_pred_flag[ x0 ][ y0 ] | ae(v) |
| if( inter_pred_flag[ x0 ][ y0 ] = = Pred_LC) { | |
| if( num_ref_idx_lc_active_minus1 > 0 ) | |
| ref_idx_lc[ x0 ][ y0 ] | ae(v) |
| mvd_coding(mvd_lc[ x0 ][ y0 ][ 0 ], | |
| mvd_lc[ x0 ][ y0 ][ 1 ]) | |
| mvp_idx_lc[ x0 ][ y0 ] | ae(v) |
| } | |
| else { /* Pred_L0 or Pred_BI */ | |
| if( num_ref_idx_l0_active_minus1 > 0 ) | |
| ref_idx_l0[ x0 ][ y0 ] | ae(v) |
| mvd_coding(mvd_l0[ x0 ][ y0 ][ 0 ], | |
| mvd_l0[ x0 ][ y0 ][ 1 ]) | |
| mvp_idx_l0[ x0 ][ y0 ] | ae(v) |
| } | |
| if( inter_pred_flag[ x0 ][ y0 ] = = Pred_BI ) { | |
| if( num_ref_idx_l1_active_minus1 > 0 ) | |
| ref_idx_l1[ x0 ][ y0 ] | ae(v) |
| mvd_coding(mvd_l1[ x0 ][ y0 ][ 0 ], | |
| mvd_l1[ x0 ][ y0 ][ 1 ]) | |
| mvp_idx_l1[ x0 ][ y0 ] | ae(v) |
| } | |
| } | |
| } | |
| } | |

Descriptions of the above syntax may be found in HEVC WD 9.

The next section will discuss multi-view and 3D video coding with respect to HEVC. In particular, the techniques of this disclosure are applicable when coding two or more views, each with a texture view component and a depth view component. The plurality of video pictures for each view may be referred to as texture view components. Each texture view component has a corresponding depth view component. The texture view components include video content (e.g., luma and chroma components of pixel values), and the depth view components may indicate relative depths of the pixels within the texture view components.

The techniques of this disclosure relate to coding 3D video data by coding texture and depth data. In general, the term “texture” is used to describe luminance (that is, brightness or “luma”) values of an image and chrominance (that is, color or “chroma”) values of the image. In some examples, a texture image may include one set of luminance data and two sets of chrominance data for blue hues (Cb) and red hues (Cr). In certain chroma formats, such as 4:2:2 or 4:2:0, the chroma data is downsampled relative to the luma data. That is, the spatial resolution of chrominance pixels is lower than the spatial resolution of corresponding luminance pixels, e.g., one-half or one-quarter of the luminance resolution.

Depth data generally describes depth values for corresponding texture data. For example, a depth image may include a set of depth pixels that each describes depth for corresponding texture data. The depth data may be used to determine horizontal disparity for the corresponding texture data. Thus, a device that receives the texture and depth data may display a first texture image for one view (e.g., a left eye view) and use the depth data to modify the first texture image to generate a second texture image for the other view (e.g., a right eye view) by offsetting pixel values of the first image by the horizontal disparity values determined based on the depth values. In general, horizontal disparity (or simply “disparity”) describes the horizontal spatial offset of a pixel in a first view to a corresponding pixel in a second view, where the two pixels correspond to the same portion of the same object as represented in the two views.

In still other examples, depth data may be defined for pixels in a z-dimension perpendicular to the image plane, such that a depth associated with a given pixel is defined relative to a zero disparity plane defined for the image. Such depth may be used to create horizontal disparity for displaying the pixel, such that the pixel is displayed differently for the left and right eyes, depending on the z-dimension depth value of the pixel relative to the zero disparity plane. The zero disparity plane may change for different portions of a video sequence, and the amount of depth relative to the zero-disparity plane may also change. Pixels located on the zero disparity plane may be defined similarly for the left and right eyes. Pixels located in front of the zero disparity plane may be displayed in different locations for the left and right eye (e.g., with horizontal disparity) so as to create a perception that the pixel appears to come out of the image in the z-direction perpendicular to the image plane. Pixels located behind the zero disparity plane may be displayed with a slight blur, to present a slight perception of depth, or may be displayed in different locations for the left and right eye (e.g., with horizontal disparity that is opposite that of pixels located in front of the zero disparity plane). Many other techniques may also be used to convey or define depth data for an image.

For each pixel in the depth view component, there may be one or more corresponding pixels in the texture view component. For instance, if the spatial resolutions of the depth view component and the texture view component are the same, each pixel in the depth view component corresponds to one pixel in the texture view component. If the spatial resolution of the depth view component is less than that of the texture view component, then each pixel in the depth view component corresponds to multiple pixels in the texture view component. The value of the pixel in the depth view component may indicate the relative depth of the corresponding one or more pixels in the texture view.

In some examples, a video encoder signals video data for the texture view components and the corresponding depth view components for each of the views. A video decoder utilizes both the video data of texture view components and the depth view components to decode the video content of the views for display. A display then displays the multiview video to produce 3D video.

Motion vector prediction, including AMVP, is proposed to be used when performing temporal or inter-view motion prediction in 3D-HEVC. In U.S. Provisional Patent Applications 61/477,561, filed Feb. 23, 2011, and 61/512,765, filed Jul. 28, 2011, both of which are incorporated by reference herein, it was proposed that motion vectors belonging to different types (e.g., normal motion vectors and disparity vectors) are considered as two categories. A disparity vector represents the difference between a video block (e.g., a block in the texture view component) in one view and a video block in another view. Disparity vectors may be used in inter-view compensation (sometimes called disparity compensated prediction). Typically, disparity vectors are be calculated between blocks in different views in the same time instance. A vector in one category, e.g., normal motion vectors, does not scale or map to a vector of the other category, e.g., disparity vectors. This means that a disparity vector does not scale to a motion vector, and vice versa. Practically speaking, if the final reference index that corresponds to a vector for a currently coded block points to one type (e.g., disparity vector or motion vector), the candidates in the AMVP or merge list belonging to other types are not used.

In both the AMVP and merge mode, a spatial or temporal candidate, if it contains a disparity vector, is treated similarly to other candidates. However, new candidates, predicted from inter-view motion prediction, may be also added into the list. Inter-view motion prediction can also be realized if the motion vector from a different view is mapped to the current block (e.g., a prediction unit).

In a previous version of 3D-HEVC, two methods were proposed to construct disparity vectors. One proposed method is to obtain the disparity vectors directly from depth view components. This method requires that the decoding of texture replies on the decoding of depth maps. Thus, the stereo or multiview (texture only) sub-bitstreams may not be extracted. This method is sometimes called the Accurate Depth Mode. The other proposed method generates disparity vectors for each pixel only from the disparity vectors and the motion vectors. This mode is sometimes called the Estimated Depth Mode.

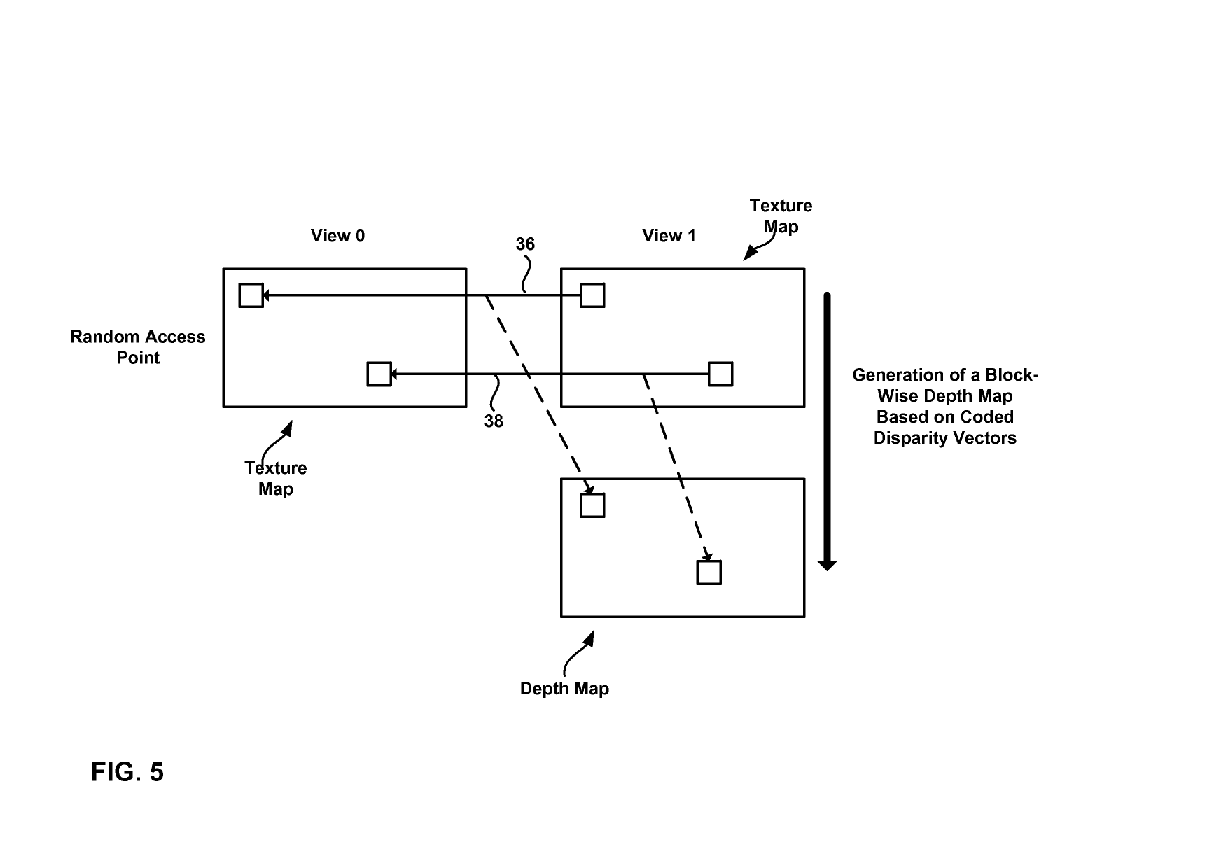

In random access units, all blocks of the base view picture are intra-coded. A base view picture is a picture in a view that is used to predict other views. In the pictures of dependent views, most blocks are typically coded using Disparity Compensation Prediction (DCP) and the remaining blocks are intra-coded. As such, a dependent view picture is predicted from the base view or another dependent view. When coding the first dependent view in a random access unit, no depth or disparity information is available. Hence, candidate disparity vectors are derived using a local neighborhood, i.e., by conventional motion vector prediction. However, after coding the first dependent view in a random access unit, the transmitted disparity vectors can be used for deriving a depth map estimate, as is illustrated in FIG. 5.

FIG. 5 is a conceptual diagram illustrating the generation of an initial depth map estimate after coding the first dependent view of a random access unit. The disparity vectors 36 and 38 used for DCP are converted into depth values and all depth samples of a disparity-compensated block are set equal to the derived depth value. The depth samples of intra-coded blocks are derived, by video decoder 30, based on the depth samples of neighboring blocks. The algorithm used for this derivation is similar to spatial intra prediction. If more than two views are coded, the obtained depth map can be mapped, by video decoder 30, into other views using the method described above, and used as depth map estimates for deriving candidate disparity vectors.

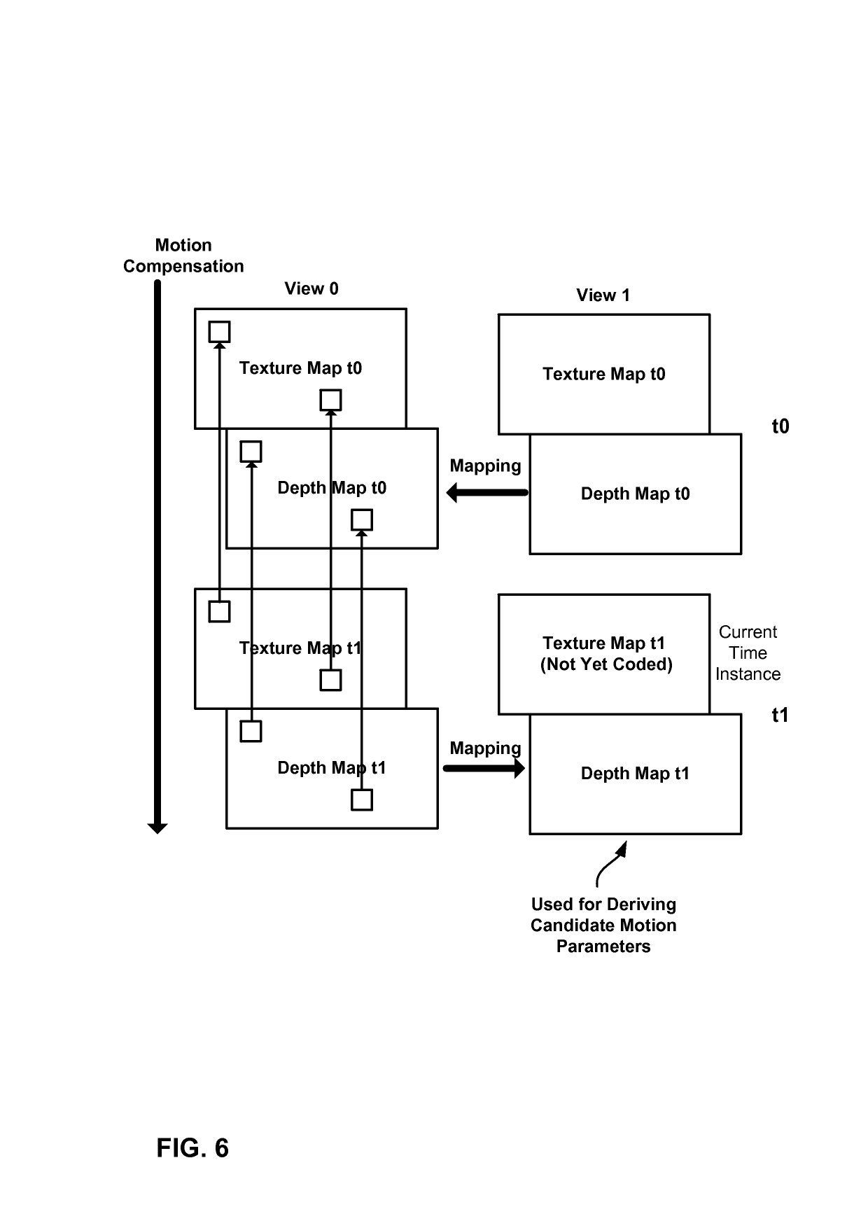

The depth map estimate for the picture of the first dependent view in a random access unit is used, by video decoder 30, for deriving a depth map for the next picture of the first dependent view. The basic principle of the algorithm is illustrated in FIG. 6. FIG. 6 is a conceptual diagram illustrating the derivation of a depth map estimate for the current picture (Texture map at t1) using motion parameters of an already coded view of the same access unit.

After coding the picture of the first dependent view (view 1) in a random access unit at time t0, the derived depth map (such as shown in FIG. 5) is mapped, by video decoder 30, into the base view (view 0) and stored together with the reconstructed picture. The next picture of the base view is typically inter-coded. For example, as shown in FIG. 1, blocks in the view 0 texture map at time t1 are inter-coded using motion compensation. For each block that is coded using MCP (Motion Compensation Prediction), the associated motion parameters are applied, by video decoder 30, to the depth map estimate. Video decoder 30 then obtains a corresponding block of depth map samples by MCP with the same motion parameters as for the associated texture block. Instead of using a reconstructed video picture, the associated depth map estimate is used as reference picture. In order to simplify the motion compensation and avoid the generation of new depth map values, the MCP process for depth blocks does not involve any interpolation. Video decoder 30 rounds the motion vectors to sample-precision before they are used. Video decoder 30 then determines the depth map samples of intra-coded blocks on the basis of neighboring depth map samples. Finally, video decoder 30 derives the depth map estimate for the first dependent view, which is used for the inter-view prediction of motion parameters, by mapping the obtained depth map estimate for the base view into the first dependent view.

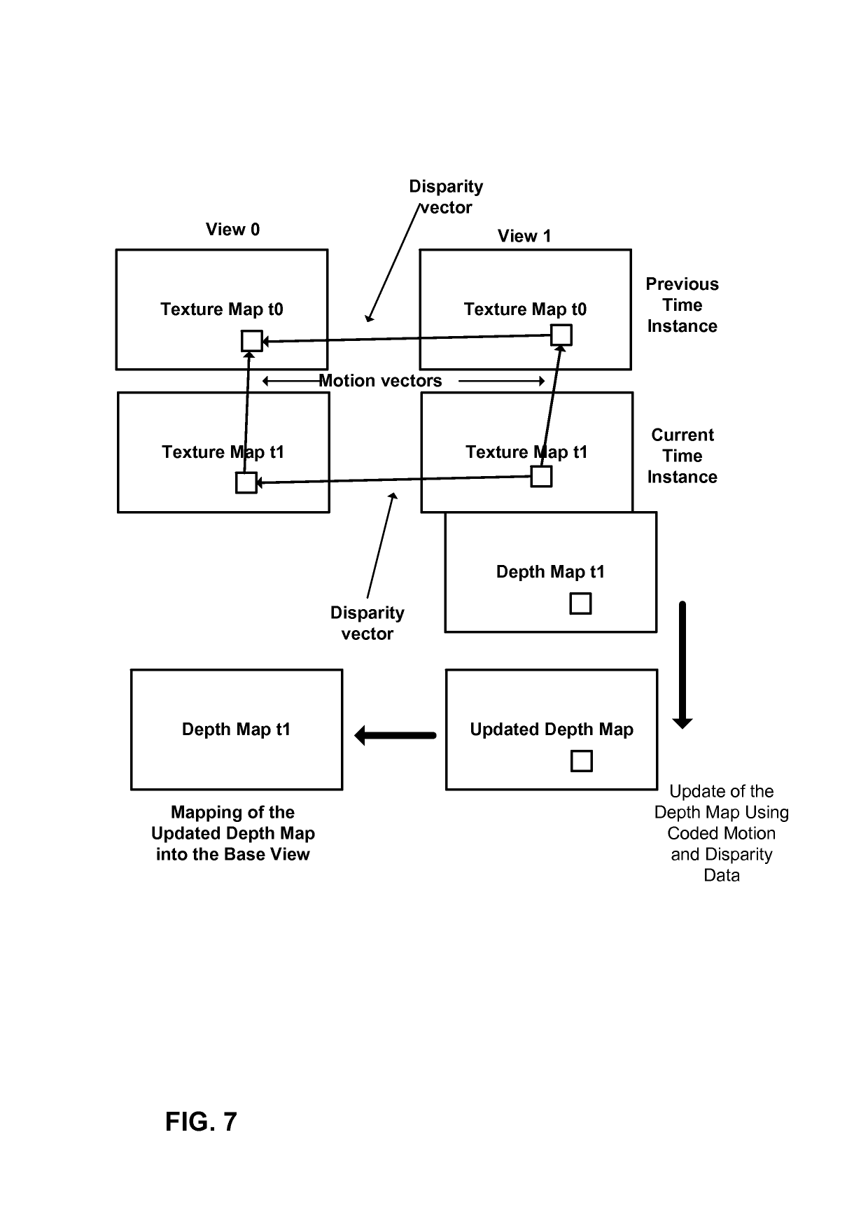

After coding the second picture of the first dependent view, the estimate of the depth map is updated, by video decoder 30, based on actually coded motion and disparity parameters, as is illustrated in FIG. 7. FIG. 7 is a conceptual diagram illustrating a process for updating a depth map estimate for a dependent view based on coded motion and disparity vectors. For blocks that are coded using DCP, video decoder 30 obtains the depth map samples by converting the disparity vector into a depth value, such as is shown in FIG. 5. The depth map samples for blocks that are coded using MCP can be obtained by MCP of the previously estimated depth maps, in a similar fashion as for the base view. In order to account for potential depth changes, a mechanism may be implemented by which new depth values are determined, by video decoder 30, by adding a depth correction. The depth correction is derived by converting the difference between the motion vectors for the current block and the corresponding reference block of the base view into a depth difference. Video decoder 30 again determines the depth values for intra-coded blocks by a spatial prediction. Video decoder 30 maps the updated depth map into the base view and stored together with the reconstructed picture. The updated depth map can also be used for deriving a depth map estimate for other views in the same access unit.

For all following pictures, the described process is repeated. After coding the base view picture, video decoder 30 determines a depth map estimate for the base view picture by MCP using the transmitted motion parameters. This estimate is mapped into the second view and used for the inter-view prediction of motion parameters. After coding the picture of the second view, video decoder 30 updates the depth map estimate using the actually used coding parameters. At the next random access unit, the inter-view motion parameter prediction is not used, and after decoding the first dependent view of the random access unit, the depth map is re-initialized as described above.

A disparity vector generated by the above method is called a Smooth Temporal-View predicted (STV) disparity vector. In both the AMVP and merge mode, a spatial or temporal candidate, if it contains a disparity vector, is treated similarly to the other candidates. However, a new candidate predicted from inter-view motion prediction is also added into the list. The STV disparity vector is mainly used for inter-view motion prediction. A candidate generated from the inter-view motion prediction may contain only normal temporal vectors, only disparity vectors, or both a normal vector and a disparity vector. However, such a candidate is added into the AMVP or merge list. For this candidate, if it contains a disparity vector, it is set to the STV disparity vector.

The currently proposed 3D-HEVC design presents several drawbacks for the motion vector prediction process when the reference index points to a picture in a different view. As one example drawback, an STV disparity vector might be inaccurate, especially due to the temporal error propagation and the error introduced when mapping the disparity vectors from one view to the other.

As another example drawback, when inter-view prediction is used, for either merge mode or AMVP mode, candidates belonging to two types may be in the same candidate list. This situation might lead to inefficient signaling of the index values to the AMVP list (mvp_idx_{—}1x), and to a lesser degree, index values to the merge list (merge_idx). In the AMVP mode, even when the reference index indicates that the reference picture is an inter-view reference, the mvp_idx_{—}10, mvp_idx_{—}11 or mvp_idx_{—}1c is signaled assuming that there are 4 (as one example) or more candidates for this index. However, when the reference picture is an inter-view reference, the potential bits used to signal the index can be smaller, or otherwise, more entries that correspond to inter-view reference pictures can be inserted into the candidate list. So, keeping the inter-view candidate in the list which is purely used for normal motion vectors, in the context of HEVC, might be less efficient.

As another example drawback, when per-pixel disparity vectors are used to derive a disparity vector to predict the disparity vector of a block, or to get the motion vector from a different view, the current proposal for 3D-HEVC uses the disparity vector of the middle position in a block of video data. This disparity vector might be less accurate for half of the pixels in current block.

In view of these drawbacks, this disclosure describes techniques to improve motion vector prediction by using multi-hypothesis disparity vector construction in 3DV.

In one example of the disclosure, rather than having a single candidate list that contains both disparity vectors and normal motion vectors, a separate motion vector candidate list and a separate disparity vector candidate list may be constructed for the AMVP mode. Similarly, two lists may be created for the merge mode. The motion vector candidate list may be used for motion vector prediction in motion compensated prediction. Likewise, the disparity vector candidate list may be used for disparity vector prediction in disparity compensated prediction. This disclosure describes the following signaling techniques to indicate which list is being used.

In the AMVP mode, the syntax elements ref_idx_{—}10, ref_idx_{—}11 or ref_idx_{—}1c are used by video decoder 30 to derive whether the current list is a motion vector candidate list or a disparity vector candidate list. That is, if the particular ref_idx that is signaled points to a different view than the view being coded, video decoder 30 uses the disparity vector candidate list. On the other hand, if the particular ref_idx that is signaled points to a temporally different picture in the same view as the view being coded, video decoder 30 uses the motion vector candidate list.

In the merge mode, since the ref_idx is not signaled, but rather inherited from the signaled neighbor block in the candidate list, video encoder 20 may signal an additional flag (e.g., a candidate list flag) to indicate whether the final vector selected as the merge candidate is from the motion vector candidate list or the disparity vector candidate list. For example, if the signaled candidate list flag=0, video decoder 30 uses the motion vector candidate list. If the signaled candidate list flag=1, video decoder 30 uses the disparity vector candidate list. In another example of the disclosure, for merge mode, a disparity vector candidate list may contain a candidate which has a disparity vector and a normal motion vector when performing bi-directional prediction.

In another example of the disclosure, in cases where depth values are determined in accurate depth mode, this disclosure describes to maintain one candidate list. However, when a candidate includes inter-view prediction (i.e., DCP) for RefPicList0 or RefPicList1, video encoder 20 and video decoder 30 may be configured to replace the disparity vector with an STV disparity vector. The STV disparity vector may be generated using the techniques described above with reference to FIGS. 5-7. In this case, when an STV disparity vector is generated from a more accurate method (e.g., a method using the depth map), the disparity vector can be made more accurate.

In another example of the disclosure, video encoder 20 and video decoder 30 may be configured to generate block level STV disparity vectors from the STV map by using the average STV values of all the samples in a block. That is, rather than calculating STV disparity vectors on a per-pixel basis, which cause error propagation, STV disparity vectors use an average of samples to reduce the likelihood of such propagation.

In another example of the disclosure, in accurate depth mode (i.e., texture is coded independently of depth), there may be situations where a candidate block in AMVP mode may have a disparity vector or a candidate block in merge mode may contain at least one disparity vector pointing to one reference picture list. In this case, video encoder 20 and video decoder 30 may be configured to generate a new motion vector for that candidate block by replacing the disparity vector with an STV disparity vector. Again, the STV disparity vector may be generated using the techniques described above with reference to FIGS. 5-7.

In another example of the disclosure, when video encoder 20 or video decoder 30 are operating in accurate depth mode, the AMVP mode may only use the STV disparity vector. If there is only one reference view for a reference picture list, only one candidate in the candidate list is generated. Thus, the syntax elements mvp_idx_{—}10, mvp_idx_{—}11 or mvp_idx_{—}1c do not need to be signaled if the reference index indicates that the reference picture is an inter-view reference. Instead, video decoder 30 may determine that the disparity vector candidate list is to be used directly from the reference index.

In another example of the disclosure, when video encoder 20 or video decoder 30 are operating in accurate depth mode, inter-view motion prediction (e.g., DCP) may utilize multi-hypothesis disparity vector construction. Multi-hypothesis disparity construction considers multiple types of disparity vectors and/or disparity vectors from different views as candidates for the disparity vector candidate list, up to the maximum length of the list. In one example, two reference views are considered for AMVP and merge mode. One of the reference views represents a view physically to the left of the current view and the other reference view represents a view physically to the right of the current view. In one example, the left reference view is the closest among the left reference views coded earlier than the current view. Likewise, the right reference view is the closest among the right reference views coded earlier than the current view.

In another example of the disclosure, when video encoder 20 or video decoder 30 are operating in estimated depth mode, multi-hypothesis disparity vector construction is used for AMVP mode. In one example of the disclosure, video encoder 20 and video decoder 30 may be configured to add two or more types of disparity vectors to the candidate list. The two or more types of disparity vectors may include spatial disparity vectors, STV disparity vectors, view disparity vectors and temporal disparity vectors, if available.

Spatial disparity vectors (SDV) are disparity vectors of neighboring blocks in the same view and picture as the current block. A disparity vector of a neighboring block is a motion vector of that block which corresponds to a reference index referring to an inter-view reference picture. The SDV points to an inter-view reference (i.e., a reference block in another view). That is, the neighboring candidate block was coded using DCP, so it has a disparity vector instead of a motion vector. The SDV is added into the disparity vector candidate list for AMVP and not the motion vector candidate list.

An STV disparity vector is calculated as described above with reference to FIGS. 5-7.

View disparity vectors (VDV) can be identified by inter-view motion prediction. When inter-view motion prediction is used for a certain block, the derived disparity vector is stored and referred to as a VDV. The derivation method for view disparity vectors is similar to that described in U.S. patent application Ser. No. 13/451,204, filed Apr. 19, 2012, and U.S. patent application Ser. No. 13/451, 161, filed Apr. 19, 2012, the entire content of both of which are incorporated by reference herein. This technique takes into consideration the physical locations, such as the view_id values or the horizontal locations. The difference in view_id between the inter-view reference for the current block and the inter-view reference pointed to by the disparity vector in the candidate block (i.e., the number of views between the two views) may be used to scale the candidate disparity vector to create the VDV. Note that such methods do not apply only to the first dependent view.

The Temporal Disparity Vector (TDV) is similar to the temporal candidate in HEVC, but the candidate is a disparity vector. That is, the co-located candidate block in another picture contains a disparity motion vector that points to a picture in another view.

In one example of the disclosure, only two of the types of disparity vector candidates listed above (i.e., the SDV, STV disparity vector, TDV and VDV) are used in the disparity vector candidate list. In another example of the disclosure, 3 types of candidates are used in the disparity vector candidate list. In another example of the disclosure, 4 types of candidates are used in the disparity vector candidate list.

In another example of the disclosure, video encoder 20 and video decoder 30 are configured to add disparity vector candidates to the disparity vector candidate list according to a priority process. In one example, the priority process involves adding all available “higher priority” disparity vectors of one type to the disparity vector candidate list before adding any candidates from a relatively lower priority. In one example, the priority order of the disparity vector types (i.e., SDV, STV disparity vector, VDV and TDV) are in the following order: SDV, STV disparity vector, VDV and TDV. That is the disparity vector candidate list will be filled with candidate blocks having SDVs first, STV disparity vector next if there are not enough candidate blocks with SDVs that fill the disparity vector candidate list, VDVs next if there are not enough candidate blocks with STV disparity vectors to fill the disparity vector candidate list, and so on.

When there are not enough candidate blocks having disparity vectors in the disparity vector candidate list, video encoder 20 and video decoder 30 are configured to generate additional STV disparity vector candidates using a different technique than was used to generate the STV disparity vectors originally considered. For example, one type of STV disparity vector candidate may be derived from the STV of the middle pixel of the current block, while an additional STV disparity vector candidate may be derived from the average value of the STVs of all the pixels of the current block. As another example, if there is more than one reference view, thus more than one disparity field, two STV disparity vector candidates may be generated.

In another example of the disclosure, the priority process for adding disparity vectors to the disparity vector candidate list operates in an alternating manner for the first two SDVs and STV disparity vectors. In this example, video encoder 20 and video decoder 30 adds the first SDV candidate block, if available, as the first candidate in the disparity vector candidate list. The first STV candidate block, if available, is then added. Then, a second SDV candidate block, if available, is added. Next, a second STV (if possible and available) is added. Lastly, if necessary to provide for the desired amount of candidate blocks (e.g., a maximum amount of candidate blocks), other candidate blocks with other disparity vector types (e.g., VDV and TDV) are then added to the disparity vector candidate list.

In another example of the disclosure, for both accurate depth mode and estimated depth mode, use of multi-hypothesis disparity vector construction applies to merge mode. Like for AMVP mode, example candidate disparity vectors may include spatial disparity vectors (SDV), STV disparity vector, view disparity vectors (VDV) and temporal disparity vectors (TDV), if available.

In one example, when constructing a disparity vector candidate list for merge mode, if an SDV, TDV or VDV candidate block contains a disparity vector pointing to one reference picture list (RefPicListX) and a normal motion vector pointing to a different reference picture list (RefPicListY, with Y equal to 1−X), video encoder 20 and video decoder 30 may be configured to add an STV disparity vector as a replacement for the other type of disparity vector (e.g., SDV, TDV, or VDV) of the candidate to generate a new candidate and the STV disparity vector is associated with a reference index in RefPicListX.

In another example of the disclosure, when constructing a disparity vector candidate list for merge mode, if an SDV, TDV or VDV candidate block is bi-directionally predicted using two disparity vectors, video encoder 20 and video decoder 30 may be configured to generate a new disparity vector candidate by replacing the disparity vector with an STV disparity vector. In case of the accurate depth mode, it is more accurate by using an STV disparity vector than an SDV or TDV disparity vector.

In another example of the disclosure, in situations where additional merge candidates are needed to fill the disparity vector candidate list, a uni-directional predicted candidate may be added with a disparity vector equal to the STV disparity vector.

In another example of the disclosure, in situations where two reference views are available, and two STV disparity vectors corresponding to the two views are available, a bi-directionally predicted candidate is added to the disparity vector candidate list with one disparity vector equal to the two STV disparity vectors.

The following section describes an example high level syntax for use with examples of this disclosure. When a depth view component (no matter if it belongs to a reference view or the current view) can be used to code the current dependent view, a flag may signaled, either in sequence level or slice level, to indicate whether there is more than one candidate considered for the disparity vector for AMVP mode and/or merge mode. Alternatively, two flags may be signaled for similar functionalities (i.e., one flag for AMVP mode (amvp_multi_flag) and another flag for merge mode (merge_multi_flag)). In some examples, texture view components are coded independently from depth view components. In this example, the above flags are not signaled and are derived to be true.

The following table shows prediction unit syntax modifications for AMVP mode:

TABLE 3
AMVP Mode Syntax

| prediction_unit( x0, y0, log2CUSize ) { | Descriptor |
|---|---|
| if( skip_flag[ x0 ][ y0 ] ) { | |
| merge_idx[ x0 ][ y0 ] | ae(v) |
| } else if( PredMode = = MODE_INTRA ) { | |
| if( PartMode == PART_2N×2N && | |
| log2CUSize >= Log2MinIPCMCUSize ) | |
| pcm_flag | ae(v) |
| if( pcm_flag ) { | |
| while ( !byte_aligned( ) ) | |
| pcm_alignment_zero_bit | u(v) |
| for( i = 0; i < 1 << ( log2CUSize << 1 ); i++ ) | |
| pcm_sample_luma[ i ] | u(v) |
| for( i = 0; i < ( 1 << ( log2CUSize << 1 ) ) >> 1; i++ ) | |
| pcm_sample_chroma[ i ] | u(v) |
| } else { | |
| prev_intra_luma_pred_flag[ x0 ][ y0 ] | ae(v) |
| if( prev_intra_luma_pred_flag[ x0 ][ y0 ] ) | |
| mpm_idx[ x0 ][ y0 ] | ae(v) |
| else | |
| rem_intra_luma_pred_mode[ x0 ][ y0 ] | ae(v) |
| intra_chroma_pred_mode[ x0 ][ y0 ] | ae(v) |
| SignaledAsChromaDC = | |
| ( chroma_pred_from_luma_enabled_flag ? | |
| intra_chroma_pred_mode[ x0 ][ y0 ] == 3 : | |
| intra_chroma_pred_mode[ x0 ][ y0 ] == 2 ) | |
| } | |
| } else { /* MODE_INTER */ | |
| merge_flag[ x0 ][ y0 ] | ae(v) |
| if( merge_flag[ x0 ][ y0 ] ) { | |
| merge_idx[ x0 ][ y0 ] | ae(v) |
| } else { | |
| if( slice_type = = B ) | |
| inter_pred_flag[ x0 ][ y0 ] | ae(v) |
| if( inter_pred_flag[ x0 ][ y0 ] = = Pred_LC) { | |
| if( num_ref_idx_lc_active_minus1 > 0 ) | |
| ref_idx_lc[ x0 ][ y0 ] | ae(v) |
| mvd_coding(mvd_lc[ x0 ][ y0 ][ 0 ], | |
| mvd_lc[ x0 ][ y0 ][ 1 ]) | |
| if (!interViewRefFlag \|\| ! amvp_multi_flag) | |
| mvp_idx_lc[ x0 ][ y0 ] | ae(v) |
| } | |
| else { /* Pred_L0 or Pred_BI */ | |
| if( num_ref_idx_l0_active_minus1 > 0 ) | |
| ref_idx_l0[ x0 ][ y0 ] | ae(v) |
| mvd_coding(mvd_l0[ x0 ][ y0 ][ 0 ], | |
| mvd_l0[ x0 ][ y0 ][ 1 ]) | |
| if (!interViewRefFlag \|\| ! amvp_multi_flag) | |
| mvp_idx_l0[ x0 ][ y0 ] | ae(v) |
| } | |
| if( inter_pred_flag[ x0 ][ y0 ] = = Pred_BI ) { | |
| if( num_ref_idx_l1_active_minus1 > 0 ) | |
| ref_idx_l1[ x0 ][ y0 ] | ae(v) |
| mvd_coding(mvd_l1[ x0 ][ y0 ][ 0 ], | |
| mvd_l1[ x0 ][ y0 ][ 1 ]) | |
| if (!interViewRefFlag \|\| ! amvp_multi_flag) | |
| mvp_idx_l1[ x0 ][ y0 ] | ae(v) |
| } | |
| } | |
| } | |
| } | |

According to the exemplary Table 3 presented above, the syntax element interViewRefFlag is derived to be 1 if the current reference index corresponds to an inter-view reference. The syntax element interViewRefFlag is derived to be 0 if the current reference index corresponds to be an inter prediction reference. When interViewRefFlag is equal to 1, the signaled index is the index in the disparity vector candidate list. When interViewRefFlag is equal to 0, the signaled index is the index in the motion vector candidate list.

For merge mode, alternative ways for the construction of the candidate list, one of which contains a disparity vector, are proposed.

In one example, each candidate in a disparity vector candidate list contains at least one disparity vector. In other words, a candidate may also contain a normal vector pointing to RefPicList0 or RefPicList1. A flag is introduced to indicate whether the current candidate is from a disparity vector candidate list.

The following table shows the prediction unit syntax for this example.

TABLE 4
Merge Mode Syntax

| prediction_unit( x0, y0, log2CUSize ) { | Descriptor |
|---|---|
| if( skip_flag[ x0 ][ y0 ] ) { | |
| disparity_vector_flag[ x0 ][ y0 ] | ae(v) |
| if (!disparity_vector_flag[ x0 ][ y0 ] \|\| ! | |
| merge_multi_flag) | |
| merge_idx[ x0 ][ y0 ] | ae(v) |
| } else if( PredMode = = MODE_INTRA) { | |
| if( PartMode == PART 2N×2N && | |
| log2CUSize >= Log2MinIPCMCUSize ) | |
| pcm_flag | ae(v) |
| if( pcm_flag ) { | |
| while ( !byte_aligned( ) ) | |
| pcm_alignment_zero_bit | u(v) |
| for( i = 0; i < 1 << ( log2CUSize << 1 ); i++ ) | |
| pcm_sample_luma[ i ] | u(v) |
| for( i = 0; i < ( 1 << ( log2CUSize << 1 ) ) >> 1; i++ ) | |
| pcm_sample_chroma[ i ] | u(v) |
| } else { | |
| prev_intra_luma_pred_flag[ x0 ][ y0 ] | ae(v) |
| if( prev_intra_luma_pred_flag[ x0 ][ y0 ] ) | |
| mpm_idx[ x0 ][ y0 ] | ae(v) |
| else | |
| rem_intra_luma_pred_mode[ x0 ][ y0 ] | ae(v) |
| intra_chroma_pred_mode[ x0 ][ y0 ] | ae(v) |
| SignaledAsChromaDC = | |
| ( chroma_pred_from_luma_enabled_flag ? | |
| intra_chroma_pred_mode[ x0 ][ y0 ] == 3 : | |
| intra_chroma_pred_mode[ x0 ][ y0 ] == 2 ) | |
| } | |
| } else { /* MODE_INTER */ | |
| merge_flag[ x0 ][ y0 ] | ae(v) |
| if( merge_flag[ x0 ][ y0 ] ) { | |
| disparity_vector_flag[ x0 ][ y0 ] | ae(v) |
| if (!disparity_vector_flag[ x0 ][ y0 ] \|\| ! | |
| merge_multi_flag) | |
| merge_idx[ x0 ][ y0 ] | ae(v) |
| } else { | |
| if( slice_type = = B ) | |
| inter_pred_flag[ x0 ][ y0 ] | ae(v) |
| if( inter_pred_flag[ x0 ][ y0 ] = = Pred_LC) { | |
| if( num_ref_idx_lc_active_minus1 > 0 ) | |
| ref_idx_lc[ x0 ][ y0 ] | ae(v) |
| mvd_coding(mvd_lc[ x0 ][ y0 ][ 0 ], | |
| mvd_lc[ x0 ][ y0 ][ 1 ]) | |
| mvp_idx_lc[ x0 ][ y0 ] | ae(v) |
| } | |
| else { /* Pred_L0 or Pred_BI */ | |
| if( num_ref_idx_l0_active_minus1 > 0 ) | |
| ref_idx_l0[ x0 ][ y0 ] | ae(v) |
| mvd_coding(mvd_l0[ x0 ][ y0 ][ 0 ], | |
| mvd_l0[ x0 ][ y0 ][ 1 ]) | |
| mvp_idx_l0[ x0 ][ y0 ] | ae(v) |
| } | |
| if( inter_pred_flag[ x0 ][ y0 ] = = Pred_BI ) { | |
| if( num_ref_idx_l1_active_minus1 > 0 ) | |
| ref_idx_l1[ x0 ][ y0 ] | ae(v) |
| mvd_coding(mvd_l1[ x0 ][ y0 ][ 0 ], | |
| mvd_l1[ x0 ][ y0 ][ 1 ]) | |
| mvp_idx_l1[ x0 ][ y0 ] | ae(v) |
| } | |
| } | |
| } | |
| } | |

According to the above Table 4, when the syntax element disparity_vector_flag[x0][y0] is equal to 1, this indicates that the chosen candidate points to an inter-view reference for one of RefPicList0 or RefPicList1. When the syntax element disparity_vector_flag[x0][y0] is equal to 0, it indicates that the chosen candidate points to only an inter prediction reference for either RefPicList0 or RefPicList1, if allowed. In some scenarios, if the number of expected disparity vectors (derived in the slice level for merge_multi_flag) is equal to 1, and disparity_vector_flag is equal to 1, the merge_idx is not signaled.

The creation of the candidates in the disparity vector candidate list is described as follows. This description also applies to the scenario when both disparity vector candidates and normal motion vector candidates are jointly considered in one list.

If, in the neighboring spatial and temporal blocks, there are no disparity vectors, this disclosure describes two methods to generate candidates for inter-view prediction (i.e., DCP):
1. Generate a candidate that is uni-directionally predicted and convert the associated disparity vector to be an STV disparity vector. In this case, the ref_idx is set pointing to the reference view.
2. Generate a candidate that is bi-directionally predicted. The ref_idx and disparity vector relative to RefPicList0 are the same as above. However, the ref_idx and motion vector relative to RefPicList1 is from a spatial/temporal candidate.

If, in the neighboring spatial and temporal blocks, there is one or more blocks that contain just one disparity vector for a reference picture list (e.g., RefPicList0), a candidate can be generated as follows:
Copy the candidate that contains a disparity vector and replace the disparity vector with an STV disparity vector.

If, in the neighboring spatial and temporal blocks, there are one or more blocks that contain two disparity vectors for both RefPicList0 and RefPicList1, a candidate may be generated in one of the following different ways.
1. Copy the candidate that contains both disparity vectors and replace the disparity vector relative to either RefPicList0 or RefPicList1 with an STV disparity vector.
2. Create a uni-directional candidate with the disparity vector equal to the STV disparity vector.
3. Create a uni-directional candidate with the disparity vector equal to the disparity vector of RefPicList0 or RefPicList1, or average of the disparity vectors of RefPicList0 and RefPicList1.

The following section will review the examples of candidate generation for a disparity vector candidate list. This example applies to the scenario where a candidate list is separated into a motion vector candidate list and a disparity vector candidate list.

If, in the spatial (e.g., SDV), temporal (e.g., TDV), or view (e.g., VDV) neighboring blocks, there is a candidate that contains a disparity vector for RefPicList0 or RefPicList1, and a motion vector for the other list, the following techniques may be applied to create a motion vector.
1. Keep the motion vector for RefPicListX (with X equal to 0 or 1) and generate the motion vector for RefPicListY (with Y equal to 1 or 0) from a different candidate.
2. Keep the motion vector for RefPicListX (with X equal to 0 or 1) and generate the motion vector for RefPicListY (with Y equal to 1 or 1) from the motion vector for RefPicListX.

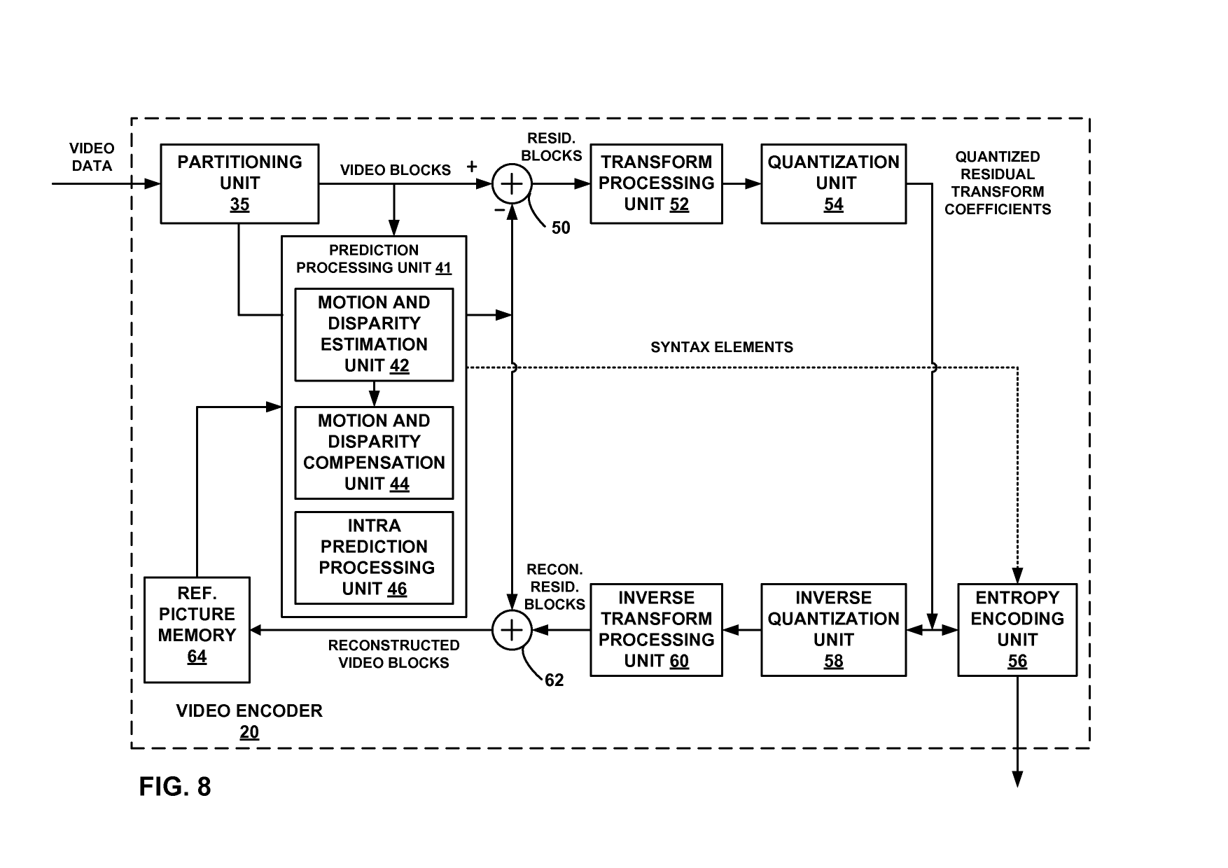

FIG. 8 is a block diagram illustrating an example video encoder 20 that may implement the techniques for multi-hypothesis disparity vector construction described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes. In addition, video encoder 20 may perform inter-view prediction between pictures in different views, as described above.

In the example of FIG. 8, video encoder 20 includes a partitioning unit 35, prediction processing unit 41, reference picture memory 64, summer 50, transform processing unit 52, quantization unit 54, and entropy encoding unit 56. Prediction processing unit 41 includes motion and disparity estimation unit 42, motion and disparity compensation unit 44, and intra prediction processing unit 46. For video block reconstruction, video encoder 20 also includes inverse quantization unit 58, inverse transform processing unit 60, and summer 62. A deblocking filter (not shown in FIG. 8) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 8, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes or interview coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 46 within prediction processing unit 41 may perform intra-predictive coding of the current video block relative to one or more neighboring blocks in the same frame or slice as the current block to be coded to provide spatial compression. Motion and disparity estimation unit 42 and motion and disparity compensation unit 44 within prediction processing unit 41 perform inter-predictive coding and/or interview coding of the current video block relative to one or more predictive blocks in one or more reference pictures and/or reference views to provide temporal and interview compression.

Motion and disparity estimation unit 42 may be configured to determine the inter-prediction mode and/or interview prediction mode for a video slice according to a predetermined pattern for a video sequence. The predetermined pattern may designate video slices in the sequence as P slices or B slices. Motion and disparity estimation unit 42 and motion and disparity compensation unit 44 may be highly integrated, but are illustrated separately for conceptual purposes. Motion estimation, performed by motion and disparity estimation unit 42, is the process of generating motion vectors, which estimate motion for video blocks. A motion vector, for example, may indicate the displacement of a PU of a video block within a current video frame or picture relative to a predictive block within a reference picture. Disparity estimation, performed by motion and disparity estimation unit 42, is the process of generating disparity vectors, which may be used to predict a currently coded block from a block in a different view.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion and disparity estimation unit 42 calculates a motion vector (for motion compensated prediction) and/or a disparity vector (for disparity compensated prediction) for a PU of a video block in an inter-coded or interview predicted slice by comparing the position of the PU to the position of a predictive block of a reference picture. The reference picture may be selected from a first reference picture list (List 0) or a second reference picture list (List 1), each of which identify one or more reference pictures stored in reference picture memory 64. For interview prediction, the reference picture is in a different view. Motion and disparity estimation unit 42 sends the calculated motion vector and/or disparity vector to entropy encoding unit 56 and motion compensation unit 44.

In some examples, motion and disparity estimation unit 42 may signal the calculated motion vector and/or disparity vector using a motion vector prediction process. As discussed above, the motion vector prediction processes may include an AMVP mode and a merge mode. In accordance with the techniques of this disclosure described above, motion and disparity estimation unit 42 may be configured to perform a motion prediction process that includes forming a disparity vector candidate list and a motion vector candidate. In particular, in one or more examples, the disparity vector candidate list may be generated using the techniques of this disclosure for multi-hypothesis disparity vector construction.

Motion compensation and/or disparity compensation, performed by motion and disparity compensation unit 44, may involve fetching or generating the predictive block based on the motion vector determined by motion estimation and/or disparity estimation, possibly performing interpolations to sub-pixel precision. Upon receiving the motion vector and/or disparity for the PU of the current video block, motion and disparity compensation unit 44 may locate the predictive block to which the motion vector and/or disparity vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion and disparity compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion and disparity estimation unit 42 and motion and disparity compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion and disparity compensation unit 44 may calculate a reference block by adding the residual block to a predictive block of one of the reference pictures within one of the reference picture lists. Motion and disparity compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion and disparity estimation unit 42 and motion and disparity compensation unit 44 as a reference block to inter-predict a block in a subsequent video frame or picture.

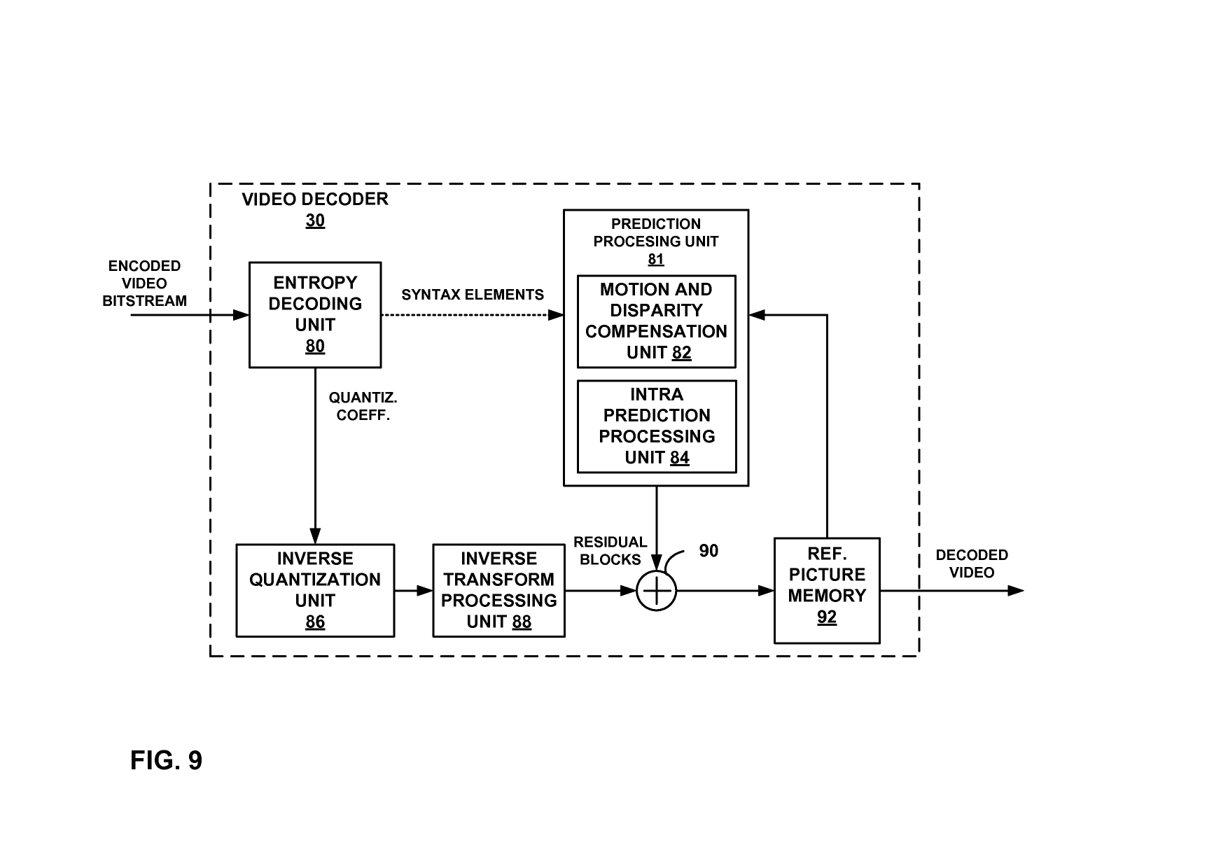

FIG. 9 is a block diagram illustrating an example video decoder 30 that may implement the techniques described in this disclosure. In the example of FIG. 9, video decoder 30 includes an entropy decoding unit 80, prediction processing unit 81, inverse quantization unit 86, inverse transformation unit 88, summer 90, and reference picture memory 92. Prediction processing unit 81 includes motion and disparity compensation unit 82 and intra prediction processing unit 84. Video decoder 30 may, in some examples, perform a decoding pass generally reciprocal to the encoding pass described with respect to video encoder 20 from FIG. 8.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, disparity vectors, and other syntax elements. Entropy decoding unit 80 forwards the motion vectors, disparity vectors, and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice or interview predicted slice, motion and disparity compensation unit 82 of prediction processing unit 81 produces predictive blocks for a video block of the current video slice based on the motion vectors, disparity vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92, also referred to as a decoded picture buffer (DPB).

Motion and disparity compensation unit 82 determines prediction information for a video block of the current video slice by parsing the motion vectors and other syntax elements, and uses the prediction information to produce the predictive blocks for the current video block being decoded. For example, motion and disparity compensation unit 82 uses some of the received syntax elements to determine a prediction mode (e.g., intra- or inter-prediction) used to code the video blocks of the video slice, an inter-prediction or interview prediction slice type (e.g., B slice, P slice, or GPB slice), construction information for one or more of the reference picture lists for the slice, motion vectors and/or disparity vectors for each inter-encoded video block of the slice, inter-prediction status for each inter-coded video block of the slice, and other information to decode the video blocks in the current video slice.

In some examples, motion and disparity compensation unit 82 may determine the signaled syntax elements indicating motion vectors and/or disparity vectors using a motion vector prediction process. As discussed above, the motion vector prediction processes may include an AMVP mode and a merge mode. In accordance with the techniques of this disclosure described above, motion and disparity compensation unit 82 may be configured to perform a motion prediction process that includes forming a disparity vector candidate list and a motion vector candidate. In particular, in one or more examples, the disparity vector candidate list may be generated using the techniques of this disclosure for multi-hypothesis disparity vector construction.

Motion and disparity compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion and disparity compensation unit 82 generates the predictive block for the current video block based on the motion vectors and/or disparity vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92 (sometimes called a decoded picture buffer), which stores reference pictures used for subsequent motion compensation. Reference picture memory 92 also stores decoded video for presentation on a display device, such as display device 32 of FIG. 1.

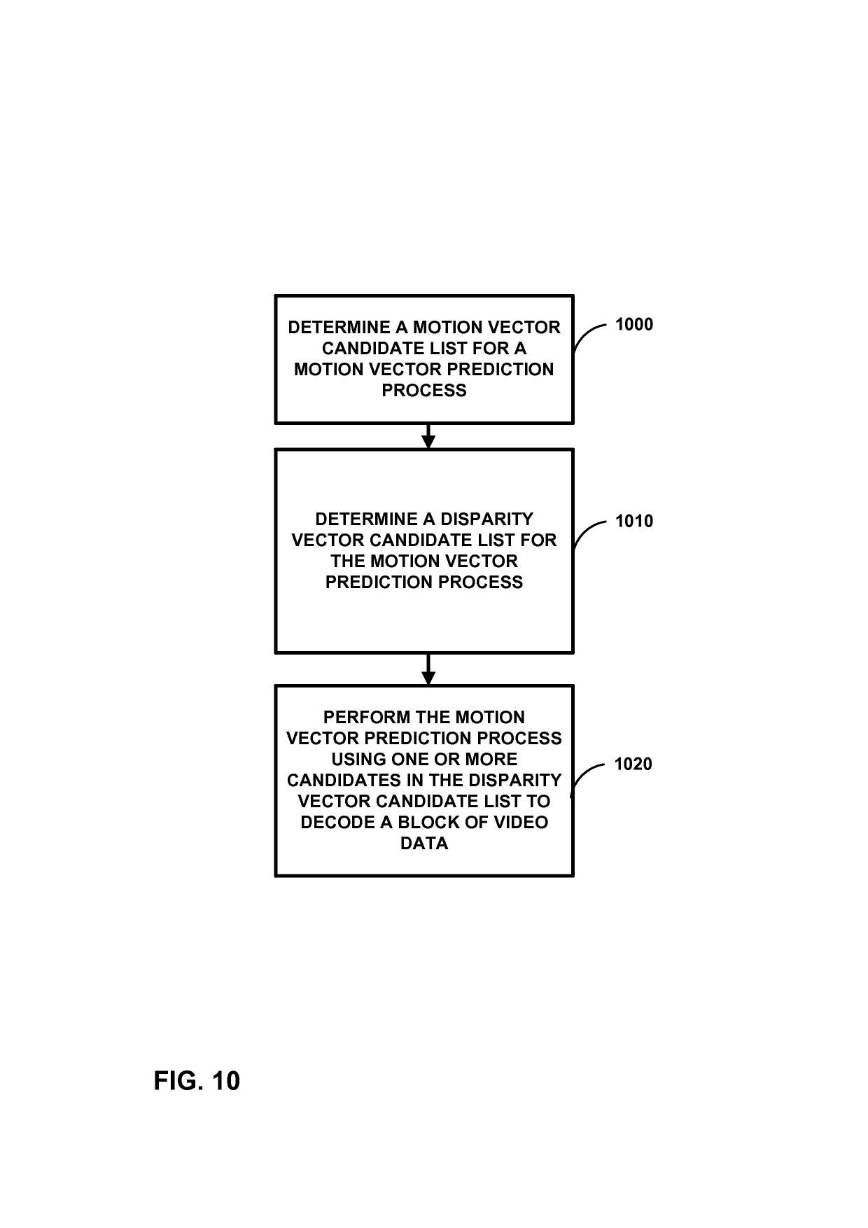

FIG. 10 is a flowchart illustrating an example decoding method according to the techniques of this disclosure. One or more hardware units of video decoder 30 may be configured to implement the method of FIG. 10. In one example, video decoder 30 is configured to determine a motion vector candidate list for a motion vector prediction process (1000), determine a disparity vector candidate list for the motion vector prediction process (1010), and perform the motion vector prediction process using one or more of the candidates in the disparity vector candidate list to decode a block of video data using the motion vector prediction process (1020).

In one example of the disclosure, the disparity vector candidate list includes at least two types of disparity vectors from a plurality of disparity vector types, the plurality including a spatial disparity vector (SDV), a view disparity vector (VDV), and a temporal disparity vector (TDV). In another example of the disclosure, the SDV is derived from a disparity motion vector of a spatially neighboring block and the TDV is derived from a disparity motion vector of a temporally neighboring block. In another example of the disclosure, the disparity vector candidate list further includes a smooth temporal-view (STV) disparity vector.

In another example of the disclosure, video decoder 30 may be configured to decode the block of video data using an advanced motion vector prediction (AMVP) mode. In another example of the disclosure, video decoder 30 may be configured to decode the block of video data using a merge mode.

In another example of the disclosure, video decoder 30 may be configured to determine the disparity vector candidate list using a priority process, wherein all available disparity vector types assigned a higher priority are added to the disparity vector candidate list before disparity vector types assigned a relatively lower priority, up to a maximum length of the disparity vector candidate list. In one example, the priority process assigns the SDV a highest priority. In another example, the priority process assigns the STV disparity vector a second highest priority, the VDV a third highest priority, and the TDV a lowest priority.

In another example of the disclosure, video decoder 30 may be further configured to determine at least one of the types of disparity vector using one of an estimated depth mode and an accurate depth mode, and decode the block of video data using a merge mode. In another example of the disclosure, the motion vector prediction process is a merge mode, and video decoder 30 may be further configured to receive a flag indicating whether the motion vector prediction process is performed using the disparity vector candidate list or the motion vector candidate list. In another example of the disclosure, the motion vector prediction process is an advanced motion vector prediction (AMVP) mode, and video decoder 30 may be further configured to receive a reference picture index, and determine whether to perform the motion vector prediction process with the disparity vector candidate list or the motion vector candidate list based on the received reference index.

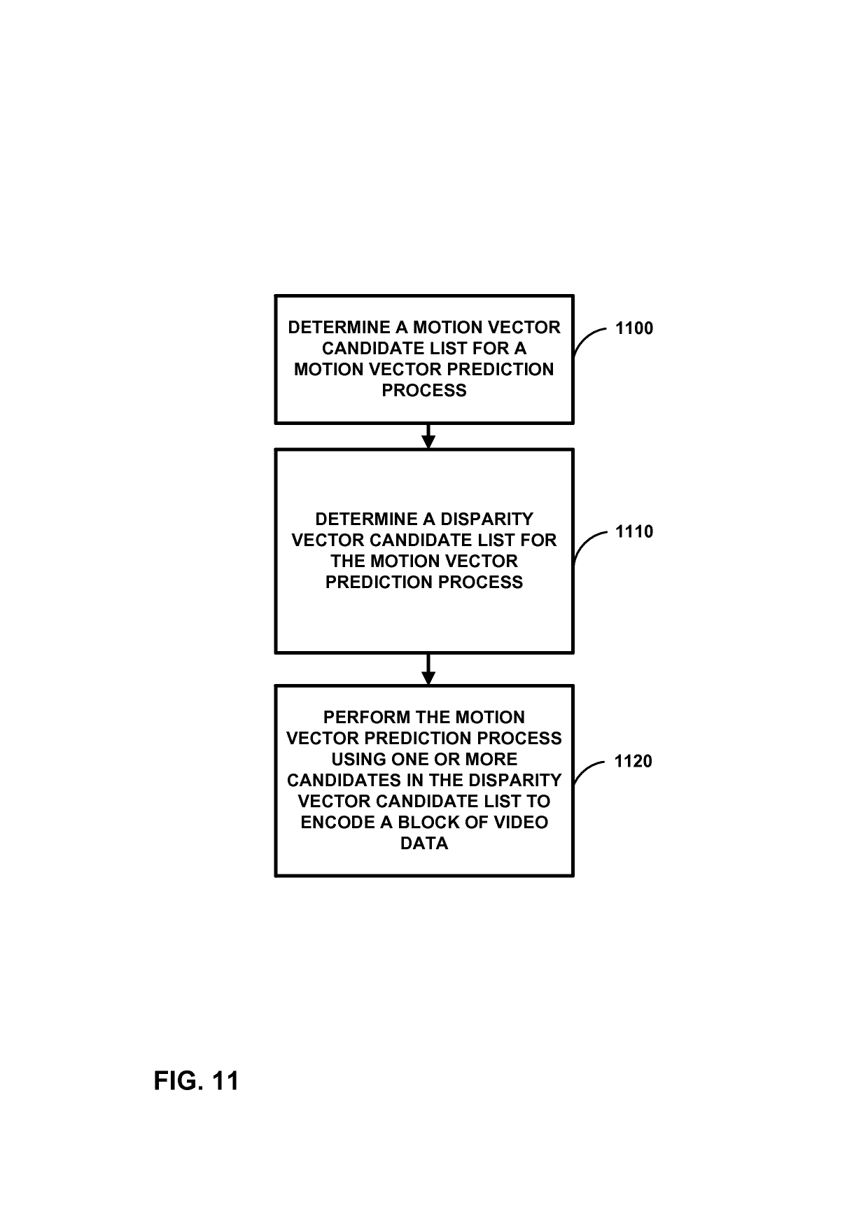

FIG. 11 is a flowchart illustrating an example encoding method according to the techniques of this disclosure. One or more hardware units of video encoder 20 may be configured to implement the method of FIG. 11. In one example of the disclosure, video encoder 20 is configured to determine a motion vector candidate list for a motion vector prediction process (1100), determine a disparity vector candidate list for the motion prediction process (1110), and perform the motion vector prediction process using one or more of the candidates in the disparity vector candidate list to encode a block of video data using the motion vector prediction process (1120).

In one example of the disclosure, the disparity vector candidate list includes at least two types of disparity vectors from a plurality of disparity vector types, the plurality including a spatial disparity vector (SDV), a view disparity vector (VDV), and a temporal disparity vector (TDV). In another example of the disclosure, the SDV is derived from a disparity motion vector of a spatially neighboring block and the TDV is derived from a disparity motion vector of a temporally neighboring block. In another example of the disclosure, the disparity vector candidate list further includes a smooth temporal-view (STV) disparity vector.

In another example of the disclosure, video encoder 20 is configured to encode the block of video data using an advanced motion vector prediction (AMVP) mode. In another example of the disclosure, video encoder 20 is configured to encode the block of video data using a merge mode.

In another example of the disclosure, video encoder 20 is configured to determine the disparity vector candidate list using a priority process, wherein all available disparity vector types assigned a higher priority are added to the disparity vector candidate list before disparity vector types assigned a relatively lower priority, up to a maximum length of the disparity vector candidate list. In one example of the disclosure, the priority process assigns the SDV a highest priority. In another example of the disclosure, the priority process assigns the STV disparity vector a second highest priority, the VDV a third highest priority, and the TDV a lowest priority.

In another example of the disclosure, video encoder 20 is configured to determine at least one of the types of disparity vector using one of an estimated depth mode and an accurate depth mode, and encode the block of video data using a merge mode. In another example of the disclosure, the motion vector prediction process is a merge mode, and video encoder 20 is configured to signal a flag indicating whether the motion vector prediction process is performed using the disparity vector candidate list or the motion vector candidate list. In another example of the disclosure, the motion vector prediction process is an advanced motion vector prediction (AMVP) mode, and video encoder 20 is configured to signal a reference index to indicate whether to perform the motion vector prediction process with the disparity vector candidate list or the motion vector candidate list based.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding multiview video data comprising:
determining a motion vector candidate list for a motion vector prediction process;
determining a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
performing the motion vector prediction process using one or more of the candidates in the disparity vector candidate list to decode a block of video data using the motion vector prediction process.

2. The method of claim 1, wherein the SDV is derived from a disparity motion vector of a spatially neighboring block and the TDV is derived from a disparity motion vector of a temporally neighboring block.

3. The method of claim 1, wherein the disparity vector candidate list further includes a smooth temporal-view (STV) disparity vector.

4. The method of claim 1, wherein decoding the block of video data using the motion vector prediction process comprises decoding the block of video data using an advanced motion vector prediction (AMVP) mode.

5. The method of claim 1, wherein decoding the block of video data using the motion vector prediction process comprises decoding the block of video data using a merge mode.

6. The method of claim 1, wherein determining the disparity vector candidate list comprises determining the disparity vector candidate list using a priority process, wherein all available disparity vector types assigned a higher priority are added to the disparity vector candidate list before disparity vector types assigned a relatively lower priority, up to a maximum length of the disparity vector candidate list.

7. The method of claim 6, wherein the priority process assigns the SDV a highest priority.

8. The method of claim 7, wherein the priority process assigns the STV disparity vector a second highest priority, the VDV a third highest priority, and the TDV a lowest priority.

9. The method of claim 1, further comprising:
determining at least one of the types of disparity vector using one of an estimated depth mode and an accurate depth mode, and
wherein decoding the block of video data using the motion vector prediction process comprises decoding the block of video data using a merge mode.

10. The method of claim 1, wherein the motion vector prediction process is a merge mode, and wherein the method further comprises:
receiving a flag indicating whether the motion vector prediction process is performed using the disparity vector candidate list or the motion vector candidate list.

11. The method of claim 1, wherein the motion vector prediction process is an advanced motion vector prediction (AMVP) mode, and wherein the method further comprises:
receiving a reference picture index; and
determining whether to perform the motion vector prediction process with the disparity vector candidate list or the motion vector candidate list based on the received reference index.

12. A method of encoding multiview video data comprising:
determining a motion vector candidate list for a motion vector prediction process;
determining a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
performing the motion vector prediction process using one or more of the candidates in the disparity vector candidate list to encode a block of video data using the motion vector prediction process.

13. The method of claim 12, wherein the SDV is derived from a disparity motion vector of a spatially neighboring block and the TDV is derived from a disparity motion vector of a temporally neighboring block.

14. The method of claim 12, wherein the disparity vector candidate list further includes a smooth temporal-view (STV) disparity vector.

15. The method of claim 12, wherein encoding the block of video data using the motion vector prediction process comprises encoding the block of video data using an advanced motion vector prediction (AMVP) mode.

16. The method of claim 12, wherein encoding the block of video data using the motion vector prediction process comprises encoding the block of video data using a merge mode.

17. The method of claim 12, wherein determining the disparity vector candidate list comprises determining the disparity vector candidate list using a priority process, wherein all available disparity vector types assigned a higher priority are added to the disparity vector candidate list before disparity vector types assigned a relatively lower priority, up to a maximum length of the disparity vector candidate list.

18. The method of claim 17, wherein the priority process assigns the SDV a highest priority.

19. The method of claim 18, where the priority process assigns the STV disparity vector a second highest priority, the VDV a third highest priority, and the TDV a lowest priority.

20. The method of claim 12, further comprising:
determining at least one of the types of disparity vector using one of an estimated depth mode and an accurate depth mode, and
wherein encoding the block of video data using the motion vector prediction process comprises encoding the block of video data using a merge mode.

21. The method of claim 12, wherein the motion vector prediction process is a merge mode, and wherein the method further comprises:
signaling a flag indicating whether the motion vector prediction process is performed using the disparity vector candidate list or the motion vector candidate list.

22. The method of claim 12, wherein the motion vector prediction process is an advanced motion vector prediction (AMVP) mode, and wherein the method further comprises:
signaling a reference picture index to indicate whether to perform the motion vector prediction process with the disparity vector candidate list or the motion vector candidate list based.

23. An apparatus configured to decode multiview video data comprising:
a video decoder configured to:
determine a motion vector candidate list for a motion vector prediction process;
determine a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
perform the motion vector prediction process using one or more of the candidates in the disparity vector candidate list to decode a block of video data using the motion vector prediction process.

24. The apparatus of claim 23, wherein the SDV is derived from a disparity motion vector of a spatially neighboring block and the TDV is derived from a disparity motion vector of a temporally neighboring block.

25. The apparatus of claim 23, wherein the disparity vector candidate list further includes a smooth temporal-view (STV) disparity vector.

26. The apparatus of claim 23, wherein the video decoder is configured to decode the block of video data using the motion vector prediction process by decoding the block of video data using an advanced motion vector prediction (AMVP) mode.

27. The apparatus of claim 23, wherein the video decoder is configured to decode the block of video data using the motion vector prediction process by decoding the block of video data using a merge mode.

28. The apparatus of claim 23, wherein the video decoder is configured to determine the disparity vector candidate list by using a priority process, wherein all available disparity vector types assigned a higher priority are added to the disparity vector candidate list before disparity vector types assigned a relatively lower priority, up to a maximum length of the disparity vector candidate list.

29. The apparatus of claim 28, wherein the priority process assigns the SDV a highest priority.

30. The apparatus of claim 29, wherein the priority process assigns the STV disparity vector a second highest priority, the VDV a third highest priority, and the TDV a lowest priority.

31. The apparatus of claim 23, wherein the video decoder is further configured to:
determine at least one of the types of disparity vector using one of an estimated depth mode and an accurate depth mode, and
decode the block of video data using a merge mode.

32. The apparatus of claim 23, wherein the motion vector prediction process is a merge mode, and wherein the video decoder is further configured to:
receive a flag indicating whether the motion vector prediction process is performed using the disparity vector candidate list or the motion vector candidate list.

33. The apparatus of claim 23, wherein the motion vector prediction process is an advanced motion vector prediction (AMVP) mode, and wherein the video decoder is further configured to:
receive a reference picture index; and
determine whether to perform the motion vector prediction process with the disparity vector candidate list or the motion vector candidate list based on the received reference index.

34. An apparatus configured to encode multiview video data comprising:
a video encoder configured to:
determine a motion vector candidate list for a motion vector prediction process;
determine a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
perform the motion vector prediction process using one or more of the candidates in the disparity vector candidate list to encode a block of video data using the motion vector prediction process.

35. The apparatus of claim 34, wherein the SDV is derived from a disparity motion vector of a spatially neighboring block and the TDV is derived from a disparity motion vector of a temporally neighboring block.

36. The apparatus of claim 34, wherein the disparity vector candidate list further includes a smooth temporal-view (STV) disparity vector.

37. The apparatus of claim 34, wherein the video encoder is further configured to encode the block of video data using the motion vector prediction process by encoding the block of video data using an advanced motion vector prediction (AMVP) mode.

38. The apparatus of claim 34, wherein the video encoder is further configured to encode the block of video data using the motion vector prediction process by encoding the block of video data using a merge mode.

39. The apparatus of claim 34, wherein the video encoder is further configured to determine the disparity vector candidate list by determining the disparity vector candidate list using a priority process, wherein all available disparity vector types assigned a higher priority are added to the disparity vector candidate list before disparity vector types assigned a relatively lower priority, up to a maximum length of the disparity vector candidate list.

40. The apparatus of claim 39, wherein the priority process assigns the SDV a highest priority.

41. The apparatus of claim 40, where the priority process assigns the STV disparity vector a second highest priority, the VDV a third highest priority, and the TDV a lowest priority.

42. The apparatus of claim 34, wherein the video encoder is further configured to:
determine at least one of the types of disparity vector using one of an estimated depth mode and an accurate depth mode, and
encode the block of video data using a merge mode.

43. The apparatus of claim 34, wherein the motion vector prediction process is a merge mode, and wherein the video encoder is further configured to:
signal a flag indicating whether the motion vector prediction process is performed using the disparity vector candidate list or the motion vector candidate list.

44. The apparatus of claim 34, wherein the motion vector prediction process is an advanced motion vector prediction (AMVP) mode, and wherein the video encoder is further configured to:
signal a reference picture index to indicate whether to perform the motion vector prediction process with the disparity vector candidate list or the motion vector candidate list based.

45. An apparatus configured to decode multiview video data comprising:
means for determining a motion vector candidate list for a motion vector prediction process;
means for determining a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
means for performing the motion vector prediction process using one or more of the candidates in the disparity vector candidate list to decode a block of video data using the motion vector prediction process.

46. An apparatus configured to encode multiview video data comprising:
means for determining a motion vector candidate list for a motion vector prediction process;
means for determining a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
means for performing the motion vector prediction process using one or more of the candidates in the disparity vector candidate list to encode a block of video data using the motion vector prediction process.

47. A computer-readable storage medium storing instructions that, when executed, cause one or more processors of a device configured to decode video data to:
determine a motion vector candidate list for a motion vector prediction process;
determine a disparity vector candidate list for the motion vector prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
perform the motion vector prediction process using one or more of the candidates in the disparity vector candidate list to decode a block of video data using the motion vector prediction process.

48. A computer-readable storage medium storing instructions that, when executed, cause one or more processors of a device configured to encode video data to:
determine a motion vector candidate list for a motion vector prediction process;
determine a disparity vector candidate list for the motion prediction process, wherein the disparity vector candidate list includes at least two types of disparity vectors from a plurality of disparity vector types, the plurality including a spatial disparity vector (SDV), a view disparity vector (VDV), and a temporal disparity vector (TDV); and
perform the motion vector prediction process using one or more of the candidates in the disparity vector candidate list to encode a block of video data using the motion vector prediction process.
